(19) United States
(12) Patent Application Publication
(10) Pub. No.: US 2007/0071782 A1
(43) Pub. Date: Mar. 29, 2007

(54) 2-Cyanobenzenesulfonamides for combating animal pests

(76) Inventors: Wolfgang von Deyn, Neustadt (DE); Ernst Baumann, Dudenhofen (DE); Michael Hofmann, Ludwigshafen (DE); Markus Kordes, Frankenthal (DE); Michael Puhl, Lampertheim (DE); Thomas Schmidt, Neustadt (DE); Livio Tedeschi, Mannheim (DE); Michael Rack, Heidelberg (DE); Toni Bucci, Fuquay Varina, NC (US); Deborah L. Culbertson, Fuquay Varina, NC (US); Henry Van Tuyl Cotter, Raleigh, NC (US); Hassan Oloumi-Sadeghi, Raleigh, NC (US)

Correspondence Address: HUTCHISON LAW GROUP PLLC, PO BOX 31686, RALEIGH, NC, 27612, US

(21) Appl. No.: 10/574,153

(22) PCT Filed: Oct. 1, 2004
(86) PCT No.: PCT/EP04/11004

§ 371 Date: Mar. 29, 2006

Related U.S. Application Data
(60) Provisional application No. 60/507,507, filed on Oct. 2, 2003.

(51) Int. Cl. A01N 25/00

(52) U.S. Cl. 424/405

(57) ABSTRACT

The invention relates to 2-cyanobenzene-sulfonamide compounds of the formula (I) where the variables R¹ to R⁵ are as defined in claim 1 and/or to their agriculturally useful salts. Moreover, the present invention relates to the use of compounds (I) and/or their salts for combating animal pests; agricultural compositions comprising such an amount of at least one compound of the general formula (I) and/or at least one agriculturally useful salt of I and at least one inert liquid and/or solid agronomically acceptable carrier that it has a pesticidal action and, if desired, at least one surfactant; and a method of combating animal pests which comprises contacting the animal pests, their habit, breeding ground, food supply, plant, seed, soil, area, material or environment in which the animal pests are growing or may grow, or the materials, plants, seeds, soils, surfaces or spaces to be protected from animal attack or infestation with a pesticidally effective amount of at least one 2-cyanobenzenesulfonamide compound of the general formula I and/or at least one agriculturally acceptable salt thereof.

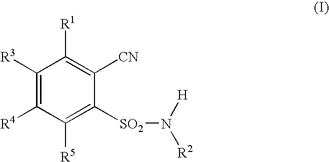

The present invention relates to 2-cyanobenzenesulfonamide compounds and to the agriculturally useful salts thereof and to compositions comprising such compounds. The invention also relates to the use of the 2-cyanobenzenesulfonamide compounds, of their salts or of compositions comprising them for combating animal pests.

Animal pests destroy growing and harvested crops and attack wooden dwelling and commercial structures, causing large economic loss to the food supply and to property. While a large number of pesticidal agents are known, due to the ability of target pests to develop resistance to said agents, there is an ongoing need for new agents for combating animal pests. In particular, animal pests such as insects and acaridae are difficult to be effectively controlled.

EP 0033984 describes substituted 2-cyanobenzenesulfonamide compounds having an aphicidal activity. The benzenesulfonamide compounds preferably carry a fluorine atom or chorine atom in the 3-position of the phenyl ring. However, the pesticidal activity of said compounds is unsatisfactory and they are only active against aphids.

It is therefore an object of the present invention to provide compounds having a good pesticidal activity, especially against difficult to control insects and acaridae.

It has been found that these objects are solved by 2-cyanobenzenesulfonamide compounds of the general formula I 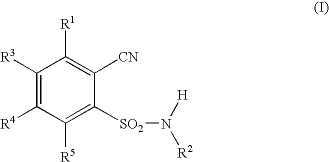
where
R¹ is C₁-C₄-alkyl, C₁-C₄-haloalkyl, C₁-C₄-alkoxy or C₁-C₄-haloalkoxy;
R² is hydrogen, C₁-C₆-alkyl, C₂-C₆-alkenyl, C₂-C₆-alkinyl, C₃-C₈-cycloalkyl or C₁-C₄-alkoxy, wherein the five last-mentioned radicals may be unsubstituted, partially or fully halogenated and/or may carry one, two, or three radicals selected from the group consisting of C₁-C₄-alkoxy, C₁-C₄-alkylthio, C₁-C₄-alkylsulfinyl, C₁-C₄-alkylsulfonyl, C₁-C₄-haloalkoxy, C₁-C₄-haloalkylthio, C₁-C₄-alkoxycarbonyl, cyano, amino, (C₁-C₄-alkyl)amino, di-(C₁-C₄-alkyl)amino, C₃-C₈-cycloalkyl and phenyl, it being possible for phenyl to be unsubstituted, partially or fully halogenated and/or to carry one, two or three substituents selected from the group consisting of C₁-C₄-alkyl, C₁-C₄-haloalkyl, C₁-C₄-alkoxy, C₁-C₄-haloalkoxy; and
R³, R⁴ and R⁵ are independently of one another selected from the group consisting of hydrogen, halogen, cyano, nitro, C₁-C₆-alkyl, C₃-C₈-cycloalkyl, C₁-C₄-haloalkyl, C₁-C₄-alkoxy, C₁-C₄-alkylthio, C₁-C₄-alkylsulfinyl, C₁-C₄-alkylsulfonyl, C₁-C₄-haloalkoxy, C₁-C₄-haloalkylthio, C₂-C₆-alkenyl, C₂-C₆-alkinyl, C₁-C₄-alkoxycarbonyl, amino, (C₁-C₄-alkyl)amino, di-(C₁-C₄-alkyl)amino, aminocarbonyl, (C₁-C₄-alkyl)aminocarbonyl and di-(C₁-C₄-alkyl)aminocarbonyl;
   and by their agriculturally acceptable salts. The compounds of the formula I and their agriculturally acceptable salts have a high pesticidal activity, especially against difficult to control insects and acaridae.

Accordingly, the present invention relates to 2-cyanobenzenesulfonamide compounds of the general formula I and to their agriculturally useful salts.

Moreover, the present invention relates to
the use of compounds I and/or their salts for combating animal pests;
agricultural compositions comprising such an amount of at least one 2-cyanobenzenesulfonamide compound of the formula I and/or at least one agriculturally useful salt of I and at least one inert liquid and/or solid agronomically acceptable carrier that it has a pesticidal action and, if desired, at least one surfactant; and
a method of combating animal pests which comprises contacting the animal pests, their habit, breeding ground, food supply, plant, seed, soil, area, material or environment in which the animal pests are growing or may grow, or the materials, plants, seeds, soils, surfaces or spaces to be protected from animal attack or infestation with a pesticidally effective amount of at least one 2-cyano-benzenesulfonamide compound of the general formula I and/or at least one agriculturally acceptable salt thereof.

In the substituents R¹ to R⁵ the compounds of the general formula I may have one or more centers of chirality, in which case they are present as mixtures of enantiomers or diastereomers. The present invention provides both the pure enantiomers or diastereomers or mixtures thereof.

Salts of the compounds of the formula I which are suitable for the use according to the invention are especially agriculturally acceptable salts. They can be formed in a customary method, e.g. by reacting the compound with an acid of the anion in question.

Suitable agriculturally useful salts are especially the salts of those cations or the acid addition salts of those acids whose cations and anions, respectively, do not have any adverse effect on the action of the compounds according to the present invention, which are useful for combating harmful insects or arachnids. Thus, suitable cations are in particular the ions of the alkali metals, preferably lithium, sodium and potassium, of the alkaline earth metals, preferably calcium, magnesium and barium, and of the transition metals, preferably manganese, copper, zinc and iron, and also the ammonium ion which may, if desired, carry one to four C₁-C₄-alkyl substituents and/or one phenyl or benzyl substituent, preferably diisopropylammonium, tetramethylammonium, tetrabutylammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogen sulfate, sulfate, dihydrogen phosphate, hydrogen phosphate, phosphate, nitrate, hydrogen carbonate, carbonate, hexafluorosilicate, hexafluorophosphate, benzoate, and the anions of C₁-C₄-alkanoic acids, preferably formate, acetate, propionate and butyrate. They can be formed by reacting the compounds of the formulae Ia and Ib with an acid of the corresponding anion, preferably of hydrochloric acid, hydrobromic acid, sulfuric acid, phosphoric acid or nitric acid.

The organic moieties mentioned in the above definitions of the variables are—like the term halogen—collective terms for individual listings of the individual group members. The prefix Cₙ-Cₘ indicates in each case the possible number of carbon atoms in the group.

The term halogen denotes in each case fluorine, bromine, chlorine or iodine.

Examples of other meanings are:

The term “C₁-C₄-alkyl” as used herein and the alkyl moieties of alkylamino and dialkylamino refer to a saturated straight-chain or branched hydrocarbon radical having 1 to 4 carbon atoms, i.e., for example methyl, ethyl, propyl, 1-methylethyl, butyl, 1-methylpropyl, 2-methylpropyl or 1,1-dimethylethyl.

The term “C₁-C₆-alkyl” as used herein refers to a saturated straight-chain or branched hydrocarbon radical having 1 to 6 carbon atoms, for example one of the radicals mentioned under C₁-C₄-alkyl and also n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl.

The term “C₁-C₄-haloalkyl” as used herein refers to a straight-chain or branched saturated alkyl radical having 1 to 4 carbon atoms (as mentioned above), where some or all of the hydrogen atoms in these radicals may be replaced by fluorine, chlorine, bromine and/or iodine, i.e., for example chloromethyl, dichloromethyl, trichloromethyl, fluoro-methyl, difluoromethyl, trifluoromethyl, chlorofluoromethyl, dichlorofluoromethyl, chlorodifluoromethyl, 2-fluoroethyl, 2-chloroethyl, 2-bromoethyl, 2-iodoethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, 2-fluoropropyl, 3-fluoropropyl, 2,2-difluoropropyl, 2,3-difluoropropyl, 2-chloropropyl, 3-chloropropyl, 2,3-dichloropropyl, 2-bromopropyl, 3-bromopropyl, 3,3,3-trifluoropropyl, 3,3,3-trichloropropyl, 2,2,3,3,3-pentafluoropropyl, heptafluoropropyl, 1-(fluoromethyl)-2-fluoroethyl, 1-(chloromethyl)-2-chloroethyl, 1-(bromomethyl)-2-bromoethyl, 4-fluorobutyl, 4-chlorobutyl, 4-bromobutyl or nonafluorobutyl.

The term “C₁-C₂-fluoroalkyl” as used herein refers to a C₁-C₂-alkyl radical which carries 1, 2, 3, 4, or 5 fluorine atoms, for example difluoromethyl, trifluoromethyl, 1-fluoroethyl, 2-fluoroethyl, 2,2-difluoroethyl, 2,2,2-trifluoroethyl, 1,1,2,2-tetrafluoroethyl or pentafluoroethyl.

The term “C₁-C₄-alkoxy” as used herein refers to a straight-chain or branched saturated alkyl radical having 1 to 4 carbon atoms (as mentioned above) which is attached via an oxygen atom, i.e., for example methoxy, ethoxy, n-propoxy, 1-methylethoxy, n-butoxy, 1-methylpropoxy, 2-methylpropoxy or 1,1-dimethylethoxy.

The term “C₁-C₄-haloalkoxy” as used herein refers to a C₁-C₁alkoxy radical as mentioned above which is partially or fully substituted by fluorine, chlorine, bromine and/or iodine, i.e., for example, chloromethoxy, dichloromethoxy, trichloromethoxy, fluoromethoxy, difluoromethoxy, trifluoromethoxy, chlorofluoromethoxy, dichlorofluoromethoxy, chlorodifluoromethoxy, 2-fluoroethoxy, 2-chloroethoxy, 2-bromoethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, pentafluoroethoxy, 2-fluoropropoxy, 3-fluoropropoxy, 2,2-difluoropropoxy, 2,3-difluoropropoxy, 2-chloropropoxy, 3-chloropropoxy, 2,3-dichloropropoxy, 2-bromopropoxy, 3-bromopropoxy, 3,3,3-trifluoropropoxy, 3,3,3-trichloropropoxy, 2,2,3,3,3-pentafluoropropoxy, heptafluoropropoxy, 1-(fluoromethyl)-2-fluoroethoxy, 1-(chloromethyl)-2-chloroethoxy, 1-(bromomethyl)-2-bromoethoxy, 4-fluorobutoxy, 4-chlorobutoxy, 4-bromobutoxy or nonafluorobutoxy.

The term “C₁-C₄-alkylthio (C₁-C₄-alkylsulfanyl: C₁-C₄-alkyl-S—)” as used herein refers to a straight-chain or branched saturated alkyl radical having 1 to 4 carbon atoms (as mentioned above) which is attached via a sulfur atom, i.e., for example methylthio, ethylthio, n-propylthio, 1-methylethylthio, butylthio, 1-methylpropylthio, 2-methylpropylthio or 1,1-dimethylethylthio.

The term “C₁-C₄-alkylsulfinyl” (C₁-C₄-alkyl-S(═O)—), as used herein refers to a straight-chain or branched saturated hydrocarbon radical (as mentioned above) having 1 to 4 carbon atoms bonded through the sulfur atom of the sulfinyl group at any bond in the alkyl radical, i.e., for example SO—CH₃, SO—C₂H₅, n-propylsulfinyl, 1-methylethyl-sulfinyl, n-butylsulfinyl, 1-methylpropylsulfinyl, 2-methylpropylsulfinyl, 1,1-dimethylethylsulfinyl, n-pentylsulfinyl, 1-methylbutylsulfinyl, 2-methylbutylsulfinyl, 3-methylbutylsulfinyl, 1,1-dimethylpropylsulfinyl, 1,2-dimethylpropylsulfinyl, 2,2-dimethylpropylsulfinyl or 1-ethylpropylsulfinyl.

The term “C₁-C₄-alkylsulfonyl” (C₁-C₄-alkyl-S(═O)₂—) as used herein refers to a straight-chain or branched saturated alkyl radical having 1 to 4 carbon atoms (as mentioned above) which is bonded via the sulfur atom of the sulfonyl group at any bond in the alkyl radical, i.e., for example SO—CH₃, SO₂—CH₅, n-propylsulfonyl, SO₂—CH(CH₃)₂, n-butylsulfonyl, 1-methylpropylsulfonyl, 2-methylpropylsulfonyl or SO₂—C(CH₃)₃.

The term “C₁-C₄-haloalkylthio” as used herein refers to a C₁-C₄-alkylthio radical as mentioned above which is partially or fully substituted by fluorine, chlorine, bromine and/or iodine, i.e., for example, fluoromethylthio, difluoromethylthio, trifluoromethylthio, chlorodifluoromethylthio, bromodifluoromethylthio, 2-fluoroethylthio, 2-chloroethylthio, 2-bromoethylthio, 2-iodoethylthio, 2,2-difluoroethylthio, 2,2,2-trifluoroethylthio, 2,2,2-trichloroethylthio, 2-chloro-2-fluoroethylthio, 2-chloro-2,2-difluoroethylthio, 2,2-dichloro-2-fluoroethylthio, pentafluoroethylthio, 2-fluoropropylthio, 3-fluoropropylthio, 2-chloropropylthio, 3-chloropropylthio, 2-bromopropylthio, 3-bromopropylthio, 2,2-difluoropropylthio, 2,3-difluoropropylthio, 2,3-dichloropropylthio, 3,3,3-trifluoropropylthio, 3,3,3-trichloropropylthio, 2,2,3,3,3-pentafluoropropylthio, heptafluoropropylthio, 1-(fluoromethyl)-2-fluoroethylthio, 1-(chloromethyl)-2-chloroethylthio, 1-(bromomethyl)-2-bromoethylthio, 4-fluorobutylthio, 4-chlorobutylthio, 4-bromobutylthio or nonafluorobutylthio.

The term “C₁-C₄-alkoxycarbonyl” as used herein refers to a straight-chain or branched alkoxy radical (as mentioned above) having 1 to 4 carbon atoms attached via the carbon atom of the carbonyl group, i.e., for example methoxycarbonyl, ethoxycarbonyl, n-propoxycarbonyl, 1-methylethoxycarbonyl, n-butoxycarbonyl, 1-methylpropoxycarbonyl, 2-methylpropoxycarbonyl or 1,1-dimethylethoxycarbonyl.

The term “(C₁-C₄-alkylamino)carbonyl as used herein refers to, for example, methylaminocarbonyl, ethylaminocarbonyl, propylaminocarbonyl, 1-methylethylaminocarbonyl, butylaminocarbonyl, 1-methylpropylaminocarbonyl, 2-methylpropylaminocarbonyl or 1,1-dimethylethylaminocarbonyl.

The term “di-(C₁-C₄-alkyl)aminocarbonyl” as used herein refers to, for example, N,N-dimethylaminocarbonyl, N,N-diethylaminocarbonyl, N,N-di-(1-methylethyl)aminocarbonyl, N,N-dipropylaminocarbonyl, N,N-dibutylaminocarbonyl, N,N-di-(1-methylpropyl)aminocarbonyl, N,N-di-(2-methylpropyl)aminocarbonyl, N,N-di-(1,1-dimethylethyl)aminocarbonyl, N-ethyl-N-methylaminocarbonyl, N-methyl-N-propylaminocarbonyl, N-methyl-N-(1-methylethyl)aminocarbonyl, N-butyl-N-methylaminocarbonyl, N-methyl-N-(1-methylpropyl)aminocarbonyl, N-methyl-N-(2-methylpropyl)aminocarbonyl, N-(1,1-dimethylethyl)-N-methylaminocarbonyl, N-ethyl-N-propylaminocarbonyl, N-ethyl-N-(1-methylethyl)aminocarbonyl, N-butyl-N-ethylaminocarbonyl, N-ethyl-N-(1-methylpropyl)aminocarbonyl, N-ethyl-N-(2-methylpropyl)aminocarbonyl, N-ethyl-N-(1,1-dimethylethyl)aminocarbonyl, N-(1-methylethyl)-N-propylaminocarbonyl, N-butyl-N-propylaminocarbonyl, N-(1-methylpropyl)-N-propylaminocarbonyl, N-(2-methylpropyl)-N-propylaminocarbonyl, N-(1,1-dimethylethyl)-N-propylaminocarbonyl, N-butyl-N-(1-methylethyl)aminocarbonyl, N-(1-methylethyl)-N-(1-methylpropyl)aminocarbonyl, N-(1-methylethyl)-N-(2-methylpropyl)aminocarbonyl, N-(1,1-dimethylethyl)-N-(1-methylethyl)aminocarbonyl, N-butyl-N-(1-methylpropyl)aminocarbonyl, N-butyl-N-(2-methylpropyl)aminocarbonyl, N-butyl-N-(1,1-dimethylethyl)aminocarbonyl, N-(1-methylpropyl)-N-(2-methylpropyl)aminocarbonyl, N-(1,1-dimethylethyl)-N-(1-methylpropyl)aminocarbonyl or N-(1,1-dimethylethyl)-N-(2-methylpropyl)aminocarbonyl.

The term “C₂-C₆-alkenyl” as used herein refers to a straight-chain or branched monounsaturated hydrocarbon radical having 2 to 6 carbon atoms and a double bond in any position, i.e., for example ethenyl, 1-propenyl, 2-propenyl, 1-methyl-ethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl.

The term “C₂-C₆-alkynyl” as used herein refers to a straight-chain or branched aliphatic hydrocarbon radical which contains a C—C triple bond and has 2 to 6 carbons atoms: for example ethynyl, prop-1-yn-1-yl, prop-2-yn-1-yl, n-but-1-yn-1-yl, n-but-1-yn-3-yl, n-but-1-yn-4-yl, n-but-2-yn-1-yl, n-pent-1-yn-1-yl, n-pent-1-yn-3-yl, n-pent-1-yn-4-yl, n-pent-1-yn-5-yl, n-pent-2-yn-1-yl, n-pent-2-yn-4-yl, n-pent-2-yn-5-yl, 3-methylbut-1-yn-3-yl, 3-methylbut-1-yn-4-yl, n-hex-1-yn-1-yl, n-hex-1-yn-3-yl, n-hex-1-yn-4-yl, n-hex-1-yn-5-yl, n-hex-1-yn-6-yl, n-hex-2-yn-1-yl, n-hex-2-yn-4-yl, n-hex-2-yn-5-yl, n-hex-2-yn-6-yl, n-hex-3-yn-1-yl, n-hex-3-yn-2-yl, 3-methylpent-1-yn-1-yl, 3-methylpent-1-yn-3-yl, 3-methylpent-1-yn-4-yl, 3-methylpent-1-yn-5-yl, 4-methylpent-1-yn-1-yl, 4-methylpent-2-yn-4-yl or 4-methylpent-2-yn-5-yl and the like.

The term “C₃-C₈-cycloalkyl” as used herein refers to a monocyclic hydrocarbon radical having 3 to 8 carbon atoms, for example cyclopropyl, cyclobutyl, cyclopentyl, cyclohexyl, cycloheptyl or cyclooctyl.

Among the 2-cyanobenzenesulfonamide compounds of the general formula I, preference is given to those in which the variables R¹ and R², independently of one another, but in particular in combination, have the meanings given below:
R¹ is C₁-C₂-alkyl, especially methyl, or C₁-C₂-alkoxy, especially methoxy;
R² is hydrogen or a linear, cyclic or branched-chain hydrocarbon radical having from 1 to 4 carbon atoms e.g. C₁-C₄-alkyl, in particular methyl, ethyl, n-propyl, 1-methylethyl, cyclopropyl, C₁-C₄-alkoxy-C₁-C₄-alkyl, in particular 2-methoxyethyl, C₁-C₄-alkylthio-C₁-C₄-alkyl, in particular 2-methylthioethyl or C₂-C₄-alkinyl, in particular prop-2-yn-1-yl(propargyl). Most preferred are compounds I wherein R² is selected from methyl, ethyl, 1-methylethyl and prop-2-yn-1-yl.

Preference is also given to 2-cyanobenzenesulfonamide compounds of the general formula I, wherein R¹ is C₁-C₄-haloalkoxy, in particular C₁-haloalkoxy, especially trifluoromethoxy, difluoromethoxy or chlorodifluoromethoxy. In these compounds R² has the meanings given above, preferably hydrogen or a linear, cyclic or branched-chain hydrocarbon radical having from 1 to 4 carbon atoms e.g. C₁-C₄-alkyl, in particular methyl, ethyl, n-propyl, 1-methylethyl, cyclopropyl, C₁-C₄-alkoxy-C₁-C₄-alkyl, in particular 2-methoxyethyl, C₁-C₄-alkylthio-C₁-C₄-alkyl, in particular 2-methylthioethyl or C₂-C₄-alkinyl, in particular prop-2-yn-1-yl(propargyl). Most preferred are compounds I wherein R² is selected from methyl, ethyl, 1-methylethyl and prop-2-yn-1-yl.

A preferred embodiment of the present invention relates to 2-cyanobenzene-sulfonamide compounds of the general formula I where the variables R¹ and R² have the meanings mentioned above and in particular the meanings given as being preferred and at least one of the radicals R³, R⁴ or R⁵ is different from hydrogen. Preferably one or two of the radicals R³, R⁴ and R⁵ represent hydrogen. Amongst these compounds preference is given to those compounds wherein R³ is different from hydrogen and preferably represents halogen, especially chlorine or fluorine, and the other radicals R⁴ and R⁵ are hydrogen.

Another preferred embodiment of the present invention relates to 2-cyanobenzene-sulfonamide compounds of the general formula I where the variables R¹ and R² have the meanings mentioned above and in particular the meanings given as being preferred and each of the radicals R³, R⁴ and R⁵ represent hydrogen.

Examples of preferred compounds of the formula I of the present invention comprise those compounds which are given in the following tables A1 to A16, wherein R³, R⁴, R⁵ are as defined in the tables and wherein R¹ and R² are given in the rows of table A:
Table A1: Compounds of the formula I, wherein each of R³, R⁴ and R⁵ are hydrogen and R¹ and R² are as defined in one row of table A
Table A2: Compounds of the formula I, wherein R³ is chlorine R⁴ and R⁵ are hydrogen and R¹ and R² are as defined in one row of table A
Table A3: Compounds of the formula I, wherein R³ is fluorine R⁴ and R⁵ are hydrogen and R¹ and R² are as defined in one row of table A
Table A4: Compounds of the formula I, wherein R³ is bromine R⁴ and R⁵ are hydrogen and R¹ and R² are as defined in one row of table A
Table A5: Compounds of the formula I, wherein R³ is iodine, R⁴ and R⁵ are hydrogen and R¹ and R² are as defined in one row of table A
Table A6: Compounds of the formula I, wherein R³ is CH₃, R⁴ and R⁵ are hydrogen and R¹ and R² are as defined in one row of table A
Table A7: Compounds of the formula I, wherein R⁴ is chlorine R³ and R⁵ are hydrogen and R¹ and R² are as defined in one row of table A
Table A8: Compounds of the formula I, wherein R⁴ is fluorine R³ and R⁵ are hydrogen and R¹ and R² are as defined in one row of table A
Table A9: Compounds of the formula I, wherein R⁴ is bromine R³ and R⁵ are hydrogen and R¹ and R² are as defined in one row of table A
Table A10: Compounds of the formula I, wherein R⁴ is iodine, R³ and R⁵ are hydrogen and R¹ and R² are as defined in one row of table A
Table A11: Compounds of the formula I, wherein R⁴ is CH₃, R³ and R⁵ are hydrogen and R¹ and R² are as defined in one row of table A
Table A12: Compounds of the formula I, wherein R⁵ is chlorine R³ and R⁴ are hydrogen and R¹ and R² are as defined in one row of table A
Table A13: Compounds of the formula I, wherein R⁵ is fluorine R³ and R⁴ are hydrogen and R¹ and R² are as defined in one row of table A
Table A14: Compounds of the formula I, wherein R⁵ is bromine R³ and R⁴ are hydrogen and R¹ and R² are as defined in one row of table A
Table A15: Compounds of the formula I, wherein R⁵ is iodine, R³ and R⁴ are hydrogen and R¹ and R² are as defined in one row of table A

Table A16: Compounds of the formula I, wherein R⁵ is CH₃, R³ and R⁴ are hydrogen and R¹ and R² are as defined in one row of table A

TABLE A

| | R¹ | R² |
|---|---|---|
| 1. | CH₃ | H |
| 2. | CH₃ | CH₃ |
| 3. | CH₃ | CH₃CH₂— |
| 4. | CH₃ | (CH₃)₂CH— |
| 5. | CH₃ | CH₃CH₂CH₂— |
| 6. | CH₃ | n-C₄H₉ |
| 7. | CH₃ | (CH₃)₃C— |
| 8. | CH₃ | (CH₃)₂CH—CH₂— |
| 9. | CH₃ | n-C₅H₁₁ |
| 10. | CH₃ | (CH₃)₂CH—CH₂—CH₂— |
| 11. | CH₃ | (C₂H₅)₂—CH— |
| 12. | CH₃ | (CH₃)₃C—CH₂— |
| 13. | CH₃ | (CH₃)₃C—CH₂—CH₂— |
| 14. | CH₃ | C₂H₅CH(CH₃)—CH₂— |
| 15. | CH₃ | CH₃—CH₂—C(CH₃)₂— |
| 16. | CH₃ | (CH₃)₂CH—CH(CH₃)— |
| 17. | CH₃ | (CH₃)₃C—CH(CH₃)— |
| 18. | CH₃ | (CH₃)₂CH—CH₂—CH(CH₃)— |
| 19. | CH₃ | CH₃—CH₂—C(CH₃)(C₂H₅)— |
| 20. | CH₃ | CH₃—CH₂—CH₂—C(CH₃)₂— |
| 21. | CH₃ | C₂H₅—CH₂—CH(CH₃)—CH₂— |
| 22. | CH₃ | cyclopropyl |
| 23. | CH₃ | cyclopropyl-CH₂— |
| 24. | CH₃ | cyclopropyl-CH(CH₃)— |
| 25. | CH₃ | cyclobutyl |
| 26. | CH₃ | cyclopentyl |
| 27. | CH₃ | cyclohexyl |
| 28. | CH₃ | HC≡C—CH₂— |
| 29. | CH₃ | HC≡C—CH(CH₃)— |
| 30. | CH₃ | HC≡C—C(CH₃)₂— |
| 31. | CH₃ | HC≡C—C(CH₃)(C₂H₅)— |
| 32. | CH₃ | HC≡C—C(CH₃)(C₃H₇)— |
| 33. | CH₃ | CH₂═CH—CH₂— |
| 34. | CH₃ | H₂C═CH—CH(CH₃)— |
| 35. | CH₃ | H₂C═CH—C(CH₃)₂— |
| 36. | CH₃ | H₂C═CH—C(C₂H₅)(CH₃)— |
| 37. | CH₃ | C₆H₅—CH₂— |
| 38. | CH₃ | 4-(CH₃)₃C—C₆H₄—CH₂— |
| 39. | CH₃ | C₆H₅—CH₂— |
| 40. | CH₃ | 4-(CH₃)₃C—C₆H₄—CH₂— |
| 41. | CH₃ | 4-Cl—C₆H₄—CH₂— |
| 42. | CH₃ | 3-(CH₃O)—C₆H₄—CH₂— |
| 43. | CH₃ | 4-(CH₃O)—C₆H₄—CH₂— |
| 44. | CH₃ | 2-(CH₃O)—C₆H₄—CH₂— |
| 45. | CH₃ | 3-Cl—C₆H₄—CH₂— |
| 46. | CH₃ | 2-Cl—C₆H₄—CH₂— |
| 47. | CH₃ | 4-(F₃C)—C₆H₄—CH₂— |
| 48. | CH₃ | NC—CH₂— |
| 49. | CH₃ | NC—CH₂—CH₂— |
| 50. | CH₃ | NC—CH₂—CH(CH₃)— |
| 51. | CH₃ | NC—CH₂—C(CH₃)₂— |
| 52. | CH₃ | NC—CH₂—CH₂—CH₂— |
| 53. | CH₃ | FH₂C—CH₂— |
| 54. | CH₃ | ClH₂C—CH₂— |
| 55. | CH₃ | BrH₂C—CH₂— |
| 56. | CH₃ | FH₂C—CH(CH₃)— |
| 57. | CH₃ | ClH₂C—CH(CH₃)— |
| 58. | CH₃ | BrH₂C—CH(CH₃)— |
| 59. | CH₃ | F₂HC—CH₂— |
| 60. | CH₃ | F₃C—CH₂— |
| 61. | CH₃ | FH₂C—CH₂—CH₂— |
| 62. | CH₃ | ClH₂C—CH₂—CH₂— |
| 63. | CH₃ | BrH₂C—CH₂—CH₂— |
| 64. | CH₃ | F₂HC—CH₂—CH₂— |
| 65. | CH₃ | F₃C—CH₂—CH₂— |
| 66. | CH₃ | CH₃—O—CH₂—CH₂— |
| 67. | CH₃ | CH₃—S—CH₂—CH₂— |
| 68. | CH₃ | CH₃—SO₂—CH₂—CH₂— |
| 69. | CH₃ | C₂H₅—O—CH₂—CH₂— |
| 70. | CH₃ | (CH₃)₂CH—O—CH₂—CH₂— |
| 71. | CH₃ | C₂H₅—S—CH₂—CH₂— |
| 72. | CH₃ | C₂H₅—SO₂—CH₂—CH₂— |
| 73. | CH₃ | (CH₃)₂N—CH₂—CH₂— |
| 74. | CH₃ | (C₂H₅)₂N—CH₂—CH₂— |
| 75. | CH₃ | [(CH₃)₂CH]₂N—CH₂—CH₂— |
| 76. | CH₃ | CH₃—O—CH₂—CH(CH₃)— |
| 77. | CH₃ | CH₃—S—CH₂—CH(CH₃)— |
| 78. | CH₃ | CH₃—SO₂—CH₂—CH(CH₃)— |
| 79. | CH₃ | C₂H₅—O—CH₂—CH(CH₃)— |
| 80. | CH₃ | C₂H₅—S—CH₂—CH(CH₃)— |
| 81. | CH₃ | C₂H₅—SO₂—CH₂—CH(CH₃)— |
| 82. | CH₃ | (CH₃)₂N—CH₂—CH(CH₃)— |
| 83. | CH₃ | (C₂H₅)₂N—CH₂—CH(CH₃)— |
| 84. | CH₃ | [(CH₃)₂CH]₂N—CH₂—CH(CH₃)— |
| 85. | CH₃ | CH₃—O—CH(CH₃)—CH₂— |
| 86. | CH₃ | CH₃—S—CH(CH₃)—CH₂— |
| 87. | CH₃ | CH₃—SO₂—CH(CH₃)—CH₂— |
| 88. | CH₃ | C₂H₅—O—CH(CH₃)—CH₂— |
| 89. | CH₃ | C₂H₅—S—CH(CH₃)—CH₂— |
| 90. | CH₃ | C₂H₅—SO₂—CH(CH₃)—CH₂— |
| 91. | CH₃ | (CH₃)₂N—CH(CH₃)—CH₂— |
| 92. | CH₃ | (C₂H₅)₂N—CH(CH₃)—CH₂— |
| 93. | CH₃ | [(CH₃)₂CH]₂N—CH(CH₃)—CH₂— |
| 94. | CH₃ | CH₃—O—CH₂—CH₂—CH₂— |
| 95. | CH₃ | CH₃—S—CH₂—CH₂—CH₂— |
| 96. | CH₃ | CH₃—SO₂—CH₂—CH₂—CH₂— |
| 97. | CH₃ | C₂H₅—O—CH₂—CH₂—CH₂— |
| 98. | CH₃ | C₂H₅—S—CH₂—CH₂—CH₂— |
| 99. | CH₃ | C₂H₅—SO₂—CH₂—CH₂—CH₂— |
| 100. | CH₃ | (CH₃)₂N—CH₂—CH₂—CH₂— |
| 101. | CH₃ | (C₂H₅)₂N—CH₂—CH₂—CH₂— |
| 102. | CH₃ | CH₃—O—CH₂—C(CH₃)₂— |
| 103. | CH₃ | CH₃—S—CH₂—C(CH₃)₂— |
| 104. | CH₃ | CH₃—SO₂—CH₂—C(CH₃)₂— |
| 105. | CH₃ | C₂H₅—O—CH₂—C(CH₃)₂— |
| 106. | CH₃ | C₂H₅—S—CH₂—C(CH₃)₂— |
| 107. | CH₃ | C₂H₅—SO₂—CH₂—C(CH₃)₂— |
| 108. | CH₃ | (CH₃)₂N—CH₂—C(CH₃)₂— |
| 109. | CH₃ | (C₂H₅)₂N—CH₂—C(CH₃)₂— |
| 110. | CH₃ | [(CH₃)₂CH]₂N—CH₂—C(CH₃)₂— |
| 111. | CH₃ | Cl—CH₂—C≡C—CH₂— |
| 112. | CH₃ | CH₃—O—C(O)—CH₂ |
| 113. | CH₃ | C₂H₅—O—C(O)—CH₂ |
| 114. | CH₃ | CH₃—O—C(O)—CH(CH₃)— |
| 115. | CH₃ | C₂H₅—O—C(O)—CH(CH₃)— |
| 116. | CH₃ | (CH₃O)₂CH—CH₂— |
| 117. | CH₃ | (C₂H₅O)₂CH—CH₂— |
| 118. | C₂H₅ | H |
| 119. | C₂H₅ | CH₃ |
| 120. | C₂H₅ | CH₃CH₂— |
| 121. | C₂H₅ | (CH₃)₂CH— |
| 122. | C₂H₅ | CH₃CH₂CH₂— |
| 123. | C₂H₅ | n-C₄H₉ |
| 124. | C₂H₅ | (CH₃)₃C— |
| 125. | C₂H₅ | (CH₃)₂CH—CH₂— |
| 126. | C₂H₅ | n-C₅H₁₁ |
| 127. | C₂H₅ | (CH₃)₂CH—CH₂—CH₂— |
| 128. | C₂H₅ | (C₂H₅)₂—CH— |
| 129. | C₂H₅ | (CH₃)₃C—CH₂— |
| 130. | C₂H₅ | (CH₃)₃C—CH₂—CH₂— |
| 131. | C₂H₅ | C₂H₅CH(CH₃)—CH₂— |
| 132. | C₂H₅ | CH₃—CH₂—C(CH₃)₂— |
| 133. | C₂H₅ | (CH₃)₂CH—CH(CH₃)— |
| 134. | C₂H₅ | (CH₃)₃C—CH(CH₃)— |
| 135. | C₂H₅ | (CH₃)₂CH—CH₂—CH(CH₃)— |
| 136. | C₂H₅ | CH₃—CH₂—C(CH₃)(C₂H₅)— |
| 137. | C₂H₅ | CH₃—CH₂—CH₂—C(CH₃)₂— |
| 138. | C₂H₅ | C₂H₅—CH₂—CH(CH₃)—CH₂— |
| 139. | C₂H₅ | cyclopropyl |
| 140. | C₂H₅ | cyclopropyl-CH₂— |
| 141. | C₂H₅ | cyclopropyl-CH(CH₃)— |
| 142. | C₂H₅ | cyclobutyl |
| 143. | C₂H₅ | cyclopentyl |
| 144. | C₂H₅ | cyclohexyl |
| 145. | C₂H₅ | HC≡C—CH₂— |
| 146. | C₂H₅ | HC≡C—CH(CH₃)— |
| 147. | C₂H₅ | HC≡C—C(CH₃)₂— |
| 148. | C₂H₅ | HC≡C—C(CH₃)(C₂H₅)— |
| 149. | C₂H₅ | HC≡C—C(CH₃)(C₃H₇)— |
| 150. | C₂H₅ | CH₂═CH—CH₂— |
| 151. | C₂H₅ | H₂C═CH—CH(CH₃)— |
| 152. | C₂H₅ | H₂C═CH—C(CH₃)₂— |
| 153. | C₂H₅ | H₂C═CH—C(C₂H₅)(CH₃)— |
| 154. | C₂H₅ | C₆H₅—CH₂— |
| 155. | C₂H₅ | 4-(CH₃)₃C—C₆H₄—CH₂— |
| 156. | C₂H₅ | C₆H₅—CH₂— |
| 157. | C₂H₅ | 4-(CH₃)₃C—C₆H₄—CH₂— |
| 158. | C₂H₅ | 4-Cl—C₆H₄—CH₂— |
| 159. | C₂H₅ | 3-(CH₃O)—C₆H₄—CH₂— |
| 160. | C₂H₅ | 4-(CH₃O)—C₆H₄—CH₂— |
| 161. | C₂H₅ | 2-(CH₃O)—C₆H₄—CH₂— |
| 162. | C₂H₅ | 3-Cl—C₆H₄—CH₂— |
| 163. | C₂H₅ | 2-Cl—C₆H₄—CH₂— |
| 164. | C₂H₅ | 4-(F₃C)—C₆H₄—CH₂— |
| 165. | C₂H₅ | NC—CH₂— |
| 166. | C₂H₅ | NC—CH₂—CH₂— |
| 167. | C₂H₅ | NC—CH₂—CH(CH₃)— |
| 168. | C₂H₅ | NC—CH₂—C(CH₃)₂— |
| 169. | C₂H₅ | NC—CH₂—CH₂—CH₂— |
| 170. | C₂H₅ | FH₂C—CH₂— |
| 171. | C₂H₅ | ClH₂C—CH₂— |
| 172. | C₂H₅ | BrH₂C—CH₂— |
| 173. | C₂H₅ | FH₂C—CH(CH₃)— |
| 174. | C₂H₅ | ClH₂C—CH(CH₃)— |
| 175. | C₂H₅ | BrH₂C—CH(CH₃)— |
| 176. | C₂H₅ | F₂HC—CH₂— |
| 177. | C₂H₅ | F₃C—CH₂— |
| 178. | C₂H₅ | FH₂C—CH₂—CH₂— |
| 179. | C₂H₅ | ClH₂C—CH₂—CH₂— |
| 180. | C₂H₅ | BrH₂C—CH₂—CH₂— |
| 181. | C₂H₅ | F₂HC—CH₂—CH₂— |
| 182. | C₂H₅ | F₃C—CH₂—CH₂— |
| 183. | C₂H₅ | CH₃—O—CH₂—CH₂— |
| 184. | C₂H₅ | CH₃—S—CH₂—CH₂— |
| 185. | C₂H₅ | CH₃—SO₂—CH₂—CH₂— |
| 186. | C₂H₅ | C₂H₅—O—CH₂—CH₂— |
| 187. | C₂H₅ | (CH₃)₂CH—O—CH₂—CH₂— |
| 188. | C₂H₅ | C₂H₅—S—CH₂—CH₂— |
| 189. | C₂H₅ | C₂H₅—SO₂—CH₂—CH₂— |
| 190. | C₂H₅ | (CH₃)₂N—CH₂—CH₂— |
| 191. | C₂H₅ | (C₂H₅)₂N—CH₂—CH₂— |
| 192. | C₂H₅ | [(CH₃)₂CH]₂N—CH₂—CH₂— |
| 193. | C₂H₅ | CH₃—O—CH₂—CH(CH₃)— |
| 194. | C₂H₅ | CH₃—S—CH₂—CH(CH₃)— |
| 195. | C₂H₅ | CH₃—SO₂—CH₂—CH(CH₃)— |
| 196. | C₂H₅ | C₂H₅—O—CH₂—CH(CH₃)— |
| 197. | C₂H₅ | C₂H₅—S—CH₂—CH(CH₃)— |
| 198. | C₂H₅ | C₂H₅—SO₂—CH₂—CH(CH₃)— |
| 199. | C₂H₅ | (CH₃)₂N—CH₂—CH(CH₃)— |
| 200. | C₂H₅ | (C₂H₅)₂N—CH₂—CH(CH₃)— |
| 201. | C₂H₅ | [(CH₃)₂CH]₂N—CH₂—CH(CH₃)— |
| 202. | C₂H₅ | CH₃—O—CH(CH₃)—CH₂— |
| 203. | C₂H₅ | CH₃—S—CH(CH₃)—CH₂— |
| 204. | C₂H₅ | CH₃—SO₂—CH(CH₃)—CH₂— |
| 205. | C₂H₅ | C₂H₅—O—CH(CH₃)—CH₂— |
| 206. | C₂H₅ | C₂H₅—S—CH(CH₃)—CH₂— |
| 207. | C₂H₅ | C₂H₅—SO₂—CH(CH₃)—CH₂— |
| 208. | C₂H₅ | (CH₃)₂N—CH(CH₃)—CH₂— |
| 209. | C₂H₅ | (C₂H₅)₂N—CH(CH₃)—CH₂— |
| 210. | C₂H₅ | [(CH₃)₂CH]₂N—CH(CH₃)—CH₂— |
| 211. | C₂H₅ | CH₃—O—CH₂—CH₂—CH₂— |
| 212. | C₂H₅ | CH₃—S—CH₂—CH₂—CH₂— |
| 213. | C₂H₅ | CH₃—SO₂—CH₂—CH₂—CH₂— |
| 214. | C₂H₅ | C₂H₅—O—CH₂—CH₂—CH₂— |
| 215. | C₂H₅ | C₂H₅—S—CH₂—CH₂—CH₂— |
| 216. | C₂H₅ | C₂H₅—SO₂—CH₂—CH₂—CH₂— |
| 217. | C₂H₅ | (CH₃)₂N—CH₂—CH₂—CH₂— |
| 218. | C₂H₅ | (C₂H₅)₂N—CH₂—CH₂—CH₂— |
| 219. | C₂H₅ | CH₃—O—CH₂—C(CH₃)₂— |
| 220. | C₂H₅ | CH₃—S—CH₂—C(CH₃)₂— |
| 221. | C₂H₅ | CH₃—SO₂—CH₂—C(CH₃)₂— |
| 222. | C₂H₅ | C₂H₅—O—CH₂—C(CH₃)₂— |
| 223. | C₂H₅ | C₂H₅—S—CH₂—C(CH₃)₂— |
| 224. | C₂H₅ | C₂H₅—SO₂—CH₂—C(CH₃)₂— |
| 225. | C₂H₅ | (CH₃)₂N—CH₂—C(CH₃)₂— |
| 226. | C₂H₅ | (C₂H₅)₂N—CH₂—C(CH₃)₂— |
| 227. | C₂H₅ | [(CH₃)₂CH]₂N—CH₂—C(CH₃)₂— |
| 228. | C₂H₅ | Cl—CH₂—C≡C—CH₂— |
| 229. | C₂H₅ | CH₃—O—C(O)—CH₂ |
| 230. | C₂H₅ | C₂H₅—O—C(O)—CH₂ |
| 231. | C₂H₅ | CH₃—O—C(O)—CH(CH₃)— |
| 232. | C₂H₅ | C₂H₅—O—C(O)—CH(CH₃)— |
| 233. | C₂H₅ | (CH₃O)₂CH—CH₂— |
| 234. | C₂H₅ | (C₂H₅O)₂CH—CH₂— |
| 235. | OCH₃ | H |
| 236. | OCH₃ | CH₃ |
| 237. | OCH₃ | CH₃CH₂— |
| 238. | OCH₃ | (CH₃)₂CH— |
| 239. | OCH₃ | CH₃CH₂CH₂— |
| 240. | OCH₃ | n-C₄H₉ |
| 241. | OCH₃ | (CH₃)₃C— |
| 242. | OCH₃ | (CH₃)₂CH—CH₂— |
| 243. | OCH₃ | n-C₅H₁₁ |
| 244. | OCH₃ | (CH₃)₂CH—CH₂—CH₂— |
| 245. | OCH₃ | (C₂H₅)₂—CH— |
| 246. | OCH₃ | (CH₃)₃C—CH₂— |
| 247. | OCH₃ | (CH₃)₃C—CH₂—CH₂— |
| 248. | OCH₃ | C₂H₅CH(CH₃)—CH₂— |
| 249. | OCH₃ | CH₃—CH₂—C(CH₃)₂— |
| 250. | OCH₃ | (CH₃)₂CH—CH(CH₃)— |
| 251. | OCH₃ | (CH₃)₃C—CH(CH₃)— |
| 252. | OCH₃ | (CH₃)₂CH—CH₂—CH(CH₃)— |
| 253. | OCH₃ | CH₃—CH₂—C(CH₃)(C₂H₅)— |
| 254. | OCH₃ | CH₃—CH₂—CH₂—C(CH₃)₂— |
| 255. | OCH₃ | C₂H₅—CH₂—CH(CH₃)—CH₂— |
| 256. | OCH₃ | cyclopropyl |
| 257. | OCH₃ | cyclopropyl-CH₂— |
| 258. | OCH₃ | cyclopropyl-CH(CH₃)— |
| 259. | OCH₃ | cyclobutyl |
| 260. | OCH₃ | cyclopentyl |
| 261. | OCH₃ | cyclohexyl |
| 262. | OCH₃ | HC≡C—CH₂— |
| 263. | OCH₃ | HC≡C—CH(CH₃)— |
| 264. | OCH₃ | HC≡C—C(CH₃)₂— |
| 265. | OCH₃ | HC≡C—C(CH₃)(C₂H₅)— |
| 266. | OCH₃ | HC≡C—C(CH₃)(C₃H₇)— |
| 267. | OCH₃ | CH₂═CH—CH₂— |
| 268. | OCH₃ | H₂C═CH—CH(CH₃)— |
| 269. | OCH₃ | H₂C═CH—C(CH₃)₂— |
| 270. | OCH₃ | H₂C═CH—C(C₂H₅)(CH₃)— |
| 271. | OCH₃ | C₆H₅—CH₂— |
| 272. | OCH₃ | 4-(CH₃)₃C—C₆H₄—CH₂— |
| 273. | OCH₃ | C₆H₅—CH₂— |
| 274. | OCH₃ | 4-(CH₃)₃C—C₆H₄—CH₂— |
| 275. | OCH₃ | 4-Cl—C₆H₄—CH₂— |
| 276. | OCH₃ | 3-(CH₃O)—C₆H₄—CH₂— |
| 277. | OCH₃ | 4-(CH₃O)—C₆H₄—CH₂— |
| 278. | OCH₃ | 2-(CH₃O)—C₆H₄—CH₂— |
| 279. | OCH₃ | 3-Cl—C₆H₄—CH₂— |
| 280. | OCH₃ | 2-Cl—C₆H₄—CH₂— |
| 281. | OCH₃ | 4-(F₃C)—C₆H₄—CH₂— |
| 282. | OCH₃ | NC—CH₂— |
| 283. | OCH₃ | NC—CH₂—CH₂— |
| 284. | OCH₃ | NC—CH₂—CH(CH₃)— |
| 285. | OCH₃ | NC—CH₂—C(CH₃)₂— |
| 286. | OCH₃ | NC—CH₂—CH₂—CH₂— |
| 287. | OCH₃ | FH₂C—CH₂— |
| 288. | OCH₃ | ClH₂C—CH₂— |
| 289. | OCH₃ | BrH₂C—CH₂— |
| 290. | OCH₃ | FH₂C—CH(CH₃)— |
| 291. | OCH₃ | ClH₂C—CH(CH₃)— |
| 292. | OCH₃ | BrH₂C—CH(CH₃)— |
| 293. | OCH₃ | F₂HC—CH₂— |
| 294. | OCH₃ | F₃C—CH₂— |
| 295. | OCH₃ | FH₂C—CH₂—CH₂— |
| 296. | OCH₃ | ClH₂C—CH₂—CH₂— |
| 297. | OCH₃ | BrH₂C—CH₂—CH₂— |
| 298. | OCH₃ | F₂HC—CH₂—CH₂— |
| 299. | OCH₃ | F₃C—CH₂—CH₂— |
| 300. | OCH₃ | CH₃—O—CH₂—CH₂— |
| 301. | OCH₃ | CH₃—S—CH₂—CH₂— |
| 302. | OCH₃ | CH₃—SO₂—CH₂—CH₂— |
| 303. | OCH₃ | C₂H₅—O—CH₂—CH₂— |
| 304. | OCH₃ | (CH₃)₂CH—O—CH₂—CH₂— |
| 305. | OCH₃ | C₂H₅—S—CH₂—CH₂— |
| 306. | OCH₃ | C₂H₅—SO₂—CH₂—CH₂— |
| 307. | OCH₃ | (CH₃)₂N—CH₂—CH₂— |
| 308. | OCH₃ | (C₂H₅)₂N—CH₂—CH₂— |
| 309. | OCH₃ | [(CH₃)₂CH]₂N—CH₂—CH₂— |
| 310. | OCH₃ | CH₃—O—CH₂—CH(CH₃)— |
| 311. | OCH₃ | CH₃—S—CH₂—CH(CH₃)— |
| 312. | OCH₃ | CH₃—SO₂—CH₂—CH(CH₃)— |
| 313. | OCH₃ | C₂H₅—O—CH₂—CH(CH₃)— |
| 314. | OCH₃ | C₂H₅—S—CH₂—CH(CH₃)— |
| 315. | OCH₃ | C₂H₅—SO₂—CH₂—CH(CH₃)— |
| 316. | OCH₃ | (CH₃)₂N—CH₂—CH(CH₃)— |
| 317. | OCH₃ | (C₂H₅)₂N—CH₂—CH(CH₃)— |
| 318. | OCH₃ | [(CH₃)₂CH]₂N—CH₂—CH(CH₃)— |
| 319. | OCH₃ | CH₃—O—CH(CH₃)—CH₂— |
| 320. | OCH₃ | CH₃—S—CH(CH₃)—CH₂— |
| 321. | OCH₃ | CH₃—SO₂—CH(CH₃)—CH₂— |
| 322. | OCH₃ | C₂H₅—O—CH(CH₃)—CH₂— |
| 323. | OCH₃ | C₂H₅—S—CH(CH₃)—CH₂— |
| 324. | OCH₃ | C₂H₅—SO₂—CH(CH₃)—CH₂— |
| 325. | OCH₃ | (CH₃)₂N—CH(CH₃)—CH₂— |
| 326. | OCH₃ | (C₂H₅)₂N—CH(CH₃)—CH₂— |
| 327. | OCH₃ | [(CH₃)₂CH]₂N—CH(CH₃)—CH₂— |
| 328. | OCH₃ | CH₃—O—CH₂—CH₂—CH₂— |
| 329. | OCH₃ | CH₃—S—CH₂—CH₂—CH₂— |
| 330. | OCH₃ | CH₃—SO₂—CH₂—CH₂—CH₂— |
| 331. | OCH₃ | C₂H₅—O—CH₂—CH₂—CH₂— |
| 332. | OCH₃ | C₂H₅—S—CH₂—CH₂—CH₂— |
| 333. | OCH₃ | C₂H₅—SO₂—CH₂—CH₂—CH₂— |
| 334. | OCH₃ | (CH₃)₂N—CH₂—CH₂—CH₂— |
| 335. | OCH₃ | (C₂H₅)₂N—CH₂—CH₂—CH₂— |
| 336. | OCH₃ | CH₃—O—CH₂—C(CH₃)₂— |
| 337. | OCH₃ | CH₃—S—CH₂—C(CH₃)₂— |
| 338. | OCH₃ | CH₃—SO₂—CH₂—C(CH₃)₂— |
| 339. | OCH₃ | C₂H₅—O—CH₂—C(CH₃)₂— |
| 340. | OCH₃ | C₂H₅—S—CH₂—C(CH₃)₂— |
| 341. | OCH₃ | C₂H₅—SO₂—CH₂—C(CH₃)₂— |
| 342. | OCH₃ | (CH₃)₂N—CH₂—C(CH₃)₂— |
| 343. | OCH₃ | (C₂H₅)₂N—CH₂—C(CH₃)₂— |
| 344. | OCH₃ | [(CH₃)₂CH]₂N—CH₂—C(CH₃)₂— |
| 345. | OCH₃ | Cl—CH₂—C≡C—CH₂— |
| 346. | OCH₃ | CH₃—O—C(O)—CH₂ |
| 347. | OCH₃ | C₂H₅—O—C(O)—CH₂ |
| 348. | OCH₃ | CH₃—O—C(O)—CH(CH₃)— |
| 349. | OCH₃ | C₂H₅—O—C(O)—CH(CH₃)— |
| 350. | OCH₃ | (CH₃O)₂CH—CH₂— |
| 351. | OCH₃ | (C₂H₅O)₂CH—CH₂— |
| 352. | OC₂H₅ | H |
| 353. | OC₂H₅ | CH₃ |
| 354. | OC₂H₅ | CH₃CH₂— |
| 355. | OC₂H₅ | (CH₃)₂CH— |
| 356. | OC₂H₅ | CH₃CH₂CH₂— |
| 357. | OC₂H₅ | n-C₄H₉ |
| 358. | OC₂H₅ | (CH₃)₃C— |
| 359. | OC₂H₅ | (CH₃)₂CH—CH₂— |
| 360. | OC₂H₅ | n-C₅H₁₁ |
| 361. | OC₂H₅ | (CH₃)₂CH—CH₂—CH₂— |
| 362. | OC₂H₅ | (C₂H₅)₂—CH— |
| 363. | OC₂H₅ | (CH₃)₃C—CH₂— |
| 364. | OC₂H₅ | (CH₃)₃C—CH₂—CH₂— |
| 365. | OC₂H₅ | C₂H₅CH(CH₃)—CH₂— |
| 366. | OC₂H₅ | CH₃—CH₂—C(CH₃)₂— |
| 367. | OC₂H₅ | (CH₃)₂CH—CH(CH₃)— |
| 368. | OC₂H₅ | (CH₃)₃C—CH(CH₃)— |
| 369. | OC₂H₅ | (CH₃)₂CH—CH₂—CH(CH₃)— |
| 370. | OC₂H₅ | CH₃—CH₂—C(CH₃)(C₂H₅)— |
| 371. | OC₂H₅ | CH₃—CH₂—CH₂—C(CH₃)₂— |
| 372. | OC₂H₅ | C₂H₅—CH₂—CH(CH₃)—CH₂— |
| 373. | OC₂H₅ | cyclopropyl |
| 374. | OC₂H₅ | cyclopropyl-CH₂— |
| 375. | OC₂H₅ | cyclopropyl-CH(CH₃)— |
| 376. | OC₂H₅ | cyclobutyl |
| 377. | OC₂H₅ | cyclopentyl |
| 378. | OC₂H₅ | cyclohexyl |
| 379. | OC₂H₅ | HC≡C—CH₂— |
| 380. | OC₂H₅ | HC≡C—CH(CH₃)— |
| 381. | OC₂H₅ | HC≡C—C(CH₃)₂— |
| 382. | OC₂H₅ | HC≡C—C(CH₃)(C₂H₅)— |
| 383. | OC₂H₅ | HC≡C—C(CH₃)(C₃H₇)— |
| 384. | OC₂H₅ | CH₂═CH—CH₂— |
| 385. | OC₂H₅ | H₂C═CH—CH(CH₃)— |
| 386. | OC₂H₅ | H₂C═CH—C(CH₃)₂— |
| 387. | OC₂H₅ | H₂C═CH—C(C₂H₅)(CH₃)— |
| 388. | OC₂H₅ | C₆H₅—CH₂— |
| 389. | OC₂H₅ | 4-(CH₃)₃C—C₆H₄—CH₂— |
| 390. | OC₂H₅ | C₆H₅—CH₂— |
| 391. | OC₂H₅ | 4-(CH₃)₃C—C₆H₄—CH₂— |
| 392. | OC₂H₅ | 4-Cl—C₆H₄—CH₂— |
| 393. | OC₂H₅ | 3-(CH₃O)—C₆H₄—CH₂— |
| 394. | OC₂H₅ | 4-(CH₃O)—C₆H₄—CH₂— |
| 395. | OC₂H₅ | 2-(CH₃O)—C₆H₄—CH₂— |
| 396. | OC₂H₅ | 3-Cl—C₆H₄—CH₂— |
| 397. | OC₂H₅ | 2-Cl—C₆H₄—CH₂— |
| 398. | OC₂H₅ | 4-(F₃C)—C₆H₄—CH₂— |
| 399. | OC₂H₅ | NC—CH₂— |
| 400. | OC₂H₅ | NC—CH₂—CH₂— |
| 401. | OC₂H₅ | NC—CH₂—CH(CH₃)— |
| 402. | OC₂H₅ | NC—CH₂—C(CH₃)₂— |
| 403. | OC₂H₅ | NC—CH₂—CH₂—CH₂— |
| 404. | OC₂H₅ | FH₂C—CH₂— |
| 405. | OC₂H₅ | ClH₂C—CH₂— |
| 406. | OC₂H₅ | BrH₂C—CH₂— |
| 407. | OC₂H₅ | FH₂C—CH(CH₃)— |
| 408. | OC₂H₅ | ClH₂C—CH(CH₃)— |
| 409. | OC₂H₅ | BrH₂C—CH(CH₃)— |
| 410. | OC₂H₅ | F₂HC—CH₂— |
| 411. | OC₂H₅ | F₃C—CH₂— |
| 412. | OC₂H₅ | FH₂C—CH₂—CH₂— |
| 413. | OC₂H₅ | ClH₂C—CH₂—CH₂— |
| 414. | OC₂H₅ | BrH₂C—CH₂—CH₂— |
| 415. | OC₂H₅ | F₂HC—CH₂—CH₂— |
| 416. | OC₂H₅ | F₃C—CH₂—CH₂— |
| 417. | OC₂H₅ | CH₃—O—CH₂—CH₂— |
| 418. | OC₂H₅ | CH₃—S—CH₂—CH₂— |
| 419. | OC₂H₅ | CH₃—SO₂—CH₂—CH₂— |
| 420. | OC₂H₅ | C₂H₅—O—CH₂—CH₂— |
| 421. | OC₂H₅ | (CH₃)₂CH—O—CH₂—CH₂— |
| 422. | OC₂H₅ | C₂H₅—S—CH₂—CH₂— |
| 423. | OC₂H₅ | C₂H₅—SO₂—CH₂—CH₂— |
| 424. | OC₂H₅ | (CH₃)₂N—CH₂—CH₂— |
| 425. | OC₂H₅ | (C₂H₅)₂N—CH₂—CH₂— |
| 426. | OC₂H₅ | [(CH₃)₂CH]₂N—CH₂—CH₂— |
| 427. | OC₂H₅ | CH₃—O—CH₂—CH(CH₃)— |
| 428. | OC₂H₅ | CH₃—S—CH₂—CH(CH₃)— |
| 429. | OC₂H₅ | CH₃—SO₂—CH₂—CH(CH₃)— |
| 430. | OC₂H₅ | C₂H₅—O—CH₂—CH(CH₃)— |
| 431. | OC₂H₅ | C₂H₅—S—CH₂—CH(CH₃)— |
| 432. | OC₂H₅ | C₂H₅—SO₂—CH₂—CH(CH₃)— |
| 433. | OC₂H₅ | (CH₃)₂N—CH₂—CH(CH₃)— |
| 434. | OC₂H₅ | (C₂H₅)₂N—CH₂—CH(CH₃)— |
| 435. | OC₂H₅ | [(CH₃)₂CH]₂N—CH₂—CH(CH₃)— |
| 436. | OC₂H₅ | CH₃—O—CH(CH₃)—CH₂— |
| 437. | OC₂H₅ | CH₃—S—CH(CH₃)—CH₂— |
| 438. | OC₂H₅ | CH₃—SO₂—CH(CH₃)—CH₂— |
| 439. | OC₂H₅ | C₂H₅—O—CH(CH₃)—CH₂— |
| 440. | OC₂H₅ | C₂H₅—S—CH(CH₃)—CH₂— |
| 441. | OC₂H₅ | C₂H₅—SO₂—CH(CH₃)—CH₂— |
| 442. | OC₂H₅ | (CH₃)₂N—CH(CH₃)—CH₂— |
| 443. | OC₂H₅ | (C₂H₅)₂N—CH(CH₃)—CH₂— |
| 444. | OC₂H₅ | [(CH₃)₂CH]₂N—CH(CH₃)—CH₂— |
| 445. | OC₂H₅ | CH₃—O—CH₂—CH₂—CH₂— |
| 446. | OC₂H₅ | CH₃—S—CH₂—CH₂—CH₂— |
| 447. | OC₂H₅ | CH₃—SO₂—CH₂—CH₂—CH₂— |
| 448. | OC₂H₅ | C₂H₅—O—CH₂—CH₂—CH₂— |
| 449. | OC₂H₅ | C₂H₅—S—CH₂—CH₂—CH₂— |
| 450. | OC₂H₅ | C₂H₅—SO₂—CH₂—CH₂—CH₂— |
| 451. | OC₂H₅ | (CH₃)₂N—CH₂—CH₂—CH₂— |
| 452. | OC₂H₅ | (C₂H₅)₂N—CH₂—CH₂—CH₂— |
| 453. | OC₂H₅ | CH₃—O—CH₂—C(CH₃)₂— |
| 454. | OC₂H₅ | CH₃—S—CH₂—C(CH₃)₂— |
| 455. | OC₂H₅ | CH₃—SO₂—CH₂—C(CH₃)₂— |
| 456. | OC₂H₅ | C₂H₅—O—CH₂—C(CH₃)₂— |
| 457. | OC₂H₅ | C₂H₅—S—CH₂—C(CH₃)₂— |
| 458. | OC₂H₅ | C₂H₅—SO₂—CH₂—C(CH₃)₂— |
| 459. | OC₂H₅ | (CH₃)₂N—CH₂—C(CH₃)₂— |
| 460. | OC₂H₅ | (C₂H₅)₂N—CH₂—C(CH₃)₂— |
| 461. | OC₂H₅ | [(CH₃)₂CH]₂N—CH₂—C(CH₃)₂— |
| 462. | OC₂H₅ | Cl—CH₂—C≡C—CH₂— |
| 463. | OC₂H₅ | CH₃—O—C(O)—CH₂ |
| 464. | OC₂H₅ | C₂H₅—O—C(O)—CH₂ |
| 465. | OC₂H₅ | CH₃—O—C(O)—CH(CH₃)— |
| 466. | OC₂H₅ | C₂H₅—O—C(O)—CH(CH₃)— |
| 467. | OC₂H₅ | (CH₃O)₂CH—CH₂— |
| 468. | OC₂H₅ | (C₂H₅O)₂CH—CH₂— |
| 469. | CF₃ | H |
| 470. | CF₃ | CH₃ |
| 471. | CF₃ | CH₃CH₂— |
| 472. | CF₃ | (CH₃)₂CH— |
| 473. | CF₃ | CH₃CH₂CH₂— |
| 474. | CF₃ | n-C₄H₉ |
| 475. | CF₃ | (CH₃)₃C— |
| 476. | CF₃ | (CH₃)₂CH—CH₂— |
| 477. | CF₃ | n-C₅H₁₁ |
| 478. | CF₃ | (CH₃)₂CH—CH₂—CH₂— |
| 479. | CF₃ | (C₂H₅)₂—CH— |
| 480. | CF₃ | (CH₃)₃C—CH₂— |
| 481. | CF₃ | (CH₃)₃C—CH₂—CH₂— |
| 482. | CF₃ | C₂H₅CH(CH₃)—CH₂— |
| 483. | CF₃ | CH₃—CH₂—C(CH₃)₂— |
| 484. | CF₃ | (CH₃)₂CH—CH(CH₃)— |
| 485. | CF₃ | (CH₃)₃C—CH(CH₃)— |
| 486. | CF₃ | (CH₃)₂CH—CH₂—CH(CH₃)— |
| 487. | CF₃ | CH₃—CH₂—C(CH₃)(C₂H₅)— |
| 488. | CF₃ | CH₃—CH₂—CH₂—C(CH₃)₂— |
| 489. | CF₃ | C₂H₅—CH₂—CH(CH₃)—CH₂— |
| 490. | CF₃ | cyclopropyl |
| 491. | CF₃ | cyclopropyl-CH₂— |
| 492. | CF₃ | cyclopropyl-CH(CH₃)— |
| 493. | CF₃ | cyclobutyl |
| 494. | CF₃ | cyclopentyl |
| 495. | CF₃ | cyclohexyl |
| 496. | CF₃ | HC≡C—CH₂— |
| 497. | CF₃ | HC≡C—CH(CH₃)— |
| 498. | CF₃ | HC≡C—C(CH₃)₂— |
| 499. | CF₃ | HC≡C—C(CH₃)(C₂H₅)— |
| 500. | CF₃ | HC≡C—C(CH₃)(C₃H₇)— |
| 501. | CF₃ | CH₂═CH—CH₂— |
| 502. | CF₃ | H₂C═CH—CH(CH₃)— |
| 503. | CF₃ | H₂C═CH—C(CH₃)₂— |
| 504. | CF₃ | H₂C═CH—C(C₂H₅)(CH₃)— |
| 505. | CF₃ | C₆H₅—CH₂— |
| 506. | CF₃ | 4-(CH₃)₃C—C₆H₄—CH₂— |
| 507. | CF₃ | C₆H₅—CH₂— |
| 508. | CF₃ | 4-(CH₃)₃C—C₆H₄—CH₂— |
| 509. | CF₃ | 4-Cl—C₆H₄—CH₂— |
| 510. | CF₃ | 3-(CH₃O)—C₆H₄—CH₂— |
| 511. | CF₃ | 4-(CH₃O)—C₆H₄—CH₂— |
| 512. | CF₃ | 2-(CH₃O)—C₆H₄—CH₂— |
| 513. | CF₃ | 3-Cl—C₆H₄—CH₂— |
| 514. | CF₃ | 2-Cl—C₆H₄—CH₂— |
| 515. | CF₃ | 4-(F₃C)—C₆H₄—CH₂— |
| 516. | CF₃ | NC—CH₂— |
| 517. | CF₃ | NC—CH₂—CH₂— |
| 518. | CF₃ | NC—CH₂—CH(CH₃)— |
| 519. | CF₃ | NC—CH₂—C(CH₃)₂— |
| 520. | CF₃ | NC—CH₂—CH₂—CH₂— |
| 521. | CF₃ | FH₂C—CH₂— |
| 522. | CF₃ | ClH₂C—CH₂— |
| 523. | CF₃ | BrH₂C—CH₂— |
| 524. | CF₃ | FH₂C—CH(CH₃)— |
| 525. | CF₃ | ClH₂C—CH(CH₃)— |
| 526. | CF₃ | BrH₂C—CH(CH₃)— |
| 527. | CF₃ | F₂HC—CH₂— |
| 528. | CF₃ | F₃C—CH₂— |
| 529. | CF₃ | FH₂C—CH₂—CH₂— |
| 530. | CF₃ | ClH₂C—CH₂—CH₂— |
| 531. | CF₃ | BrH₂C—CH₂—CH₂— |
| 532. | CF₃ | F₂HC—CH₂—CH₂— |
| 533. | CF₃ | F₃C—CH₂—CH₂— |
| 534. | CF₃ | CH₃—O—CH₂—CH₂— |
| 535. | CF₃ | CH₃—S—CH₂—CH₂— |
| 536. | CF₃ | CH₃—SO₂—CH₂—CH₂— |
| 537. | CF₃ | C₂H₅—O—CH₂—CH₂— |
| 538. | CF₃ | (CH₃)₂CH—O—CH₂—CH₂— |
| 539. | CF₃ | C₂H₅—S—CH₂—CH₂— |
| 540. | CF₃ | C₂H₅—SO₂—CH₂—CH₂— |
| 541. | CF₃ | (CH₃)₂N—CH₂—CH₂— |
| 542. | CF₃ | (C₂H₅)₂N—CH₂—CH₂— |
| 543. | CF₃ | [(CH₃)₂CH]₂N—CH₂—CH₂— |
| 544. | CF₃ | CH₃—O—CH₂—CH(CH₃)— |
| 545. | CF₃ | CH₃—S—CH₂—CH(CH₃)— |
| 546. | CF₃ | CH₃—SO₂—CH₂—CH(CH₃)— |
| 547. | CF₃ | C₂H₅—O—CH₂—CH(CH₃)— |
| 548. | CF₃ | C₂H₅—S—CH₂—CH(CH₃)— |
| 549. | CF₃ | C₂H₅—SO₂—CH₂—CH(CH₃)— |
| 550. | CF₃ | (CH₃)₂N—CH₂—CH(CH₃)— |
| 551. | CF₃ | (C₂H₅)₂N—CH₂—CH(CH₃)— |
| 552. | CF₃ | [(CH₃)₂CH]₂N—CH₂—CH(CH₃)— |
| 553. | CF₃ | CH₃—O—CH(CH₃)—CH₂— |
| 554. | CF₃ | CH₃—S—CH(CH₃)—CH₂— |
| 555. | CF₃ | CH₃—SO₂—CH(CH₃)—CH₂— |
| 556. | CF₃ | C₂H₅—O—CH(CH₃)—CH₂— |
| 557. | CF₃ | C₂H₅—S—CH(CH₃)—CH₂— |
| 558. | CF₃ | C₂H₅—SO₂—CH(CH₃)—CH₂— |
| 559. | CF₃ | (CH₃)₂N—CH(CH₃)—CH₂— |
| 560. | CF₃ | (C₂H₅)₂N—CH(CH₃)—CH₂— |
| 561. | CF₃ | [(CH₃)₂CH]₂N—CH(CH₃)—CH₂— |
| 562. | CF₃ | CH₃—O—CH₂—CH₂—CH₂— |
| 563. | CF₃ | CH₃—S—CH₂—CH₂—CH₂— |
| 564. | CF₃ | CH₃—SO₂—CH₂—CH₂—CH₂— |
| 565. | CF₃ | C₂H₅—O—CH₂—CH₂—CH₂— |
| 566. | CF₃ | C₂H₅—S—CH₂—CH₂—CH₂— |
| 567. | CF₃ | C₂H₅—SO₂—CH₂—CH₂—CH₂— |
| 568. | CF₃ | (CH₃)₂N—CH₂—CH₂—CH₂— |
| 569. | CF₃ | (C₂H₅)₂N—CH₂—CH₂—CH₂— |
| 570. | CF₃ | CH₃—O—CH₂—C(CH₃)₂— |
| 571. | CF₃ | CH₃—S—CH₂—C(CH₃)₂— |
| 572. | CF₃ | CH₃—SO₂—CH₂—C(CH₃)₂— |
| 573. | CF₃ | C₂H₅—O—CH₂—C(CH₃)₂— |
| 574. | CF₃ | C₂H₅—S—CH₂—C(CH₃)₂— |
| 575. | CF₃ | C₂H₅—SO₂—CH₂—C(CH₃)₂— |
| 576. | CF₃ | (CH₃)₂N—CH₂—C(CH₃)₂— |
| 577. | CF₃ | (C₂H₅)₂N—CH₂—C(CH₃)₂— |
| 578. | CF₃ | [(CH₃)₂CH]₂N—CH₂—C(CH₃)₂— |
| 579. | CF₃ | Cl—CH₂—C≡C—CH₂— |
| 580. | CF₃ | CH₃—O—C(O)—CH₂ |
| 581. | CF₃ | C₂H₅—O—C(O)—CH₂ |
| 582. | CF₃ | CH₃—O—C(O)—CH(CH₃)— |
| 583. | CF₃ | C₂H₅—O—C(O)—CH(CH₃)— |
| 584. | CF₃ | (CH₃O)₂CH—CH₂— |
| 585. | CF₃ | (C₂H₅O)₂CH—CH₂— |
| 586. | OCHF₂ | H |
| 587. | OCHF₂ | CH₃ |
| 588. | OCHF₂ | CH₃CH₂— |
| 589. | OCHF₂ | (CH₃)₂CH— |
| 590. | OCHF₂ | CH₃CH₂CH₂— |
| 591. | OCHF₂ | n-C₄H₉ |
| 592. | OCHF₂ | (CH₃)₃C— |
| 593 | OCHF₂ | (CH₃)₂CH—CH₂— |
| 594. | OCHF₂ | n-C₅H₁₁ |
| 595. | OCHF₂ | (CH₃)₂CH—CH₂—CH₂— |
| 596. | OCHF₂ | (C₂H₅)₂—CH— |
| 597. | OCHF₂ | (CH₃)₃C—CH₂— |
| 598. | OCHF₂ | (CH₃)₃C—CH₂—CH₂— |
| 599. | OCHF₂ | C₂H₅CH(CH₃)—CH₂— |
| 600. | OCHF₂ | CH₃—CH₂—C(CH₃)₂— |
| 601. | OCHF₂ | (CH₃)₂CH—CH(CH₃)— |
| 602. | OCHF₂ | (CH₃)₃C—CH(CH₃)— |
| 603. | OCHF₂ | (CH₃)₂CH—CH₂—CH(CH₃)— |
| 604. | OCHF₂ | CH₃—CH₂—C(CH₃)(C₂H₅)— |
| 605. | OCHF₂ | CH₃—CH₂—CH₂—C(CH₃)₂— |
| 606. | OCHF₂ | C₂H₅—CH₂—CH(CH₃)—CH₂— |
| 607. | OCHF₂ | cyclopropyl |
| 608. | OCHF₂ | cyclopropyl-CH₂— |
| 609. | OCHF₂ | cyclopropyl-CH(CH₃)— |
| 610. | OCHF₂ | cyclobutyl |
| 611. | OCHF₂ | cyclopentyl |
| 612. | OCHF₂ | cyclohexyl |
| 613. | OCHF₂ | HC≡C—CH₂— |
| 614. | OCHF₂ | HC≡C—CH(CH₃)— |
| 615. | OCHF₂ | HC≡C—C(CH₃)₂— |
| 616. | OCHF₂ | HC≡C—C(CH₃)(C₂H₅)— |
| 617. | OCHF₂ | HC≡C—C(CH₃)(C₃H₇)— |
| 618. | OCHF₂ | CH₂═CH—CH₂— |
| 619. | OCHF₂ | H₂C═CH—CH(CH₃)— |
| 620. | OCHF₂ | H₂C═CH—C(CH₃)₂— |
| 621. | OCHF₂ | H₂C═CH—C(C₂H₅)(CH₃)— |
| 622. | OCHF₂ | C₆H₅—CH₂— |
| 623. | OCHF₂ | 4-(CH₃)₃C—C₆H₄—CH₂— |
| 624. | OCHF₂ | C₆H₅—CH₂— |
| 625. | OCHF₂ | 4-(CH₃)₃C—C₆H₄—CH₂— |
| 626. | OCHF₂ | 4-Cl—C₆H₄—CH₂— |
| 627. | OCHF₂ | 3-(CH₃O)—C₆H₄—CH₂— |
| 628. | OCHF₂ | 4-(CH₃O)—C₆H₄—CH₂— |
| 629. | OCHF₂ | 2-(CH₃O)—C₆H₄—CH₂— |
| 630. | OCHF₂ | 3-Cl—C₆H₄—CH₂— |
| 631. | OCHF₂ | 2-Cl—C₆H₄—CH₂— |
| 632. | OCHF₂ | 4-(F₃C)—C₆H₄—CH₂— |
| 633. | OCHF₂ | NC—CH₂— |
| 634. | OCHF₂ | NC—CH₂—CH₂— |
| 635. | OCHF₂ | NC—CH₂—CH(CH₃)— |
| 636. | OCHF₂ | NC—CH₂—C(CH₃)₂— |
| 637. | OCHF₂ | NC—CH₂—CH₂—CH₂— |
| 638. | OCHF₂ | FH₂C—CH₂— |
| 639. | OCHF₂ | ClH₂C—CH₂— |
| 640. | OCHF₂ | BrH₂C—CH₂— |
| 641. | OCHF₂ | FH₂C—CH(CH₃)— |
| 642. | OCHF₂ | ClH₂C—CH(CH₃)— |
| 643. | OCHF₂ | BrH₂C—CH(CH₃)— |
| 644. | OCHF₂ | F₂HC—CH₂— |
| 645. | OCHF₂ | F₃C—CH₂— |
| 646. | OCHF₂ | FH₂C—CH₂—CH₂— |
| 647. | OCHF₂ | ClH₂C—CH₂—CH₂— |
| 648. | OCHF₂ | BrH₂C—CH₂—CH₂— |
| 649. | OCHF₂ | F₂HC—CH₂—CH₂— |
| 650. | OCHF₂ | F₃C—CH₂—CH₂— |
| 651. | OCHF₂ | CH₃—O—CH₂—CH₂— |
| 652. | OCHF₂ | CH₃—S—CH₂—CH₂— |
| 653. | OCHF₂ | CH₃—SO₂—CH₂—CH₂— |
| 654. | OCHF₂ | C₂H₅—O—CH₂—CH₂— |
| 655. | OCHF₂ | (CH₃)₂CH—O—CH₂—CH₂— |
| 656. | OCHF₂ | C₂H₅—S—CH₂—CH₂— |
| 657. | OCHF₂ | C₂H₅—SO₂—CH₂—CH₂— |
| 658. | OCHF₂ | (CH₃)₂N—CH₂—CH₂— |
| 659. | OCHF₂ | (C₂H₅)₂N—CH₂—CH₂— |
| 660. | OCHF₂ | [(CH₃)₂CH]₂N—CH₂—CH₂— |
| 661. | OCHF₂ | CH₃—O—CH₂—CH(CH₃)— |
| 662. | OCHF₂ | CH₃—S—CH₂—CH(CH₃)— |
| 663. | OCHF₂ | CH₃—SO₂—CH₂—CH(CH₃)— |
| 664. | OCHF₂ | C₂H₅—O—CH₂—CH(CH₃)— |
| 665. | OCHF₂ | C₂H₅—S—CH₂—CH(CH₃)— |
| 666. | OCHF₂ | C₂H₅—SO₂—CH₂—CH(CH₃)— |
| 667. | OCHF₂ | (CH₃)₂N—CH₂—CH(CH₃)— |
| 668. | OCHF₂ | (C₂H₅)₂N—CH₂—CH(CH₃)— |
| 669. | OCHF₂ | [(CH₃)₂CH]₂N—CH₂—CH(CH₃)— |
| 670. | OCHF₂ | CH₃—O—CH(CH₃)—CH₂— |
| 671. | OCHF₂ | CH₃—S—CH(CH₃)—CH₂— |
| 672. | OCHF₂ | CH₃—SO₂—CH(CH₃)—CH₂— |
| 673. | OCHF₂ | C₂H₅—O—CH(CH₃)—CH₂— |
| 674. | OCHF₂ | C₂H₅—S—CH(CH₃)—CH₂— |
| 675. | OCHF₂ | C₂H₅—SO₂—CH(CH₃)—CH₂— |
| 676. | OCHF₂ | (CH₃)₂N—CH(CH₃)—CH₂— |
| 677. | OCHF₂ | (C₂H₅)₂N—CH(CH₃)—CH₂— |
| 678. | OCHF₂ | [(CH₃)₂CH]₂N—CH(CH₃)—CH₂— |
| 679. | OCHF₂ | CH₃—O—CH₂—CH₂—CH₂— |
| 680. | OCHF₂ | CH₃—S—CH₂—CH₂—CH₂— |
| 681. | OCHF₂ | CH₃—SO₂—CH₂—CH₂—CH₂— |
| 682. | OCHF₂ | C₂H₅—O—CH₂—CH₂—CH₂— |
| 683. | OCHF₂ | C₂H₅—S—CH₂—CH₂—CH₂— |
| 684. | OCHF₂ | C₂H₅—SO₂—CH₂—CH₂—CH₂— |
| 685. | OCHF₂ | (CH₃)₂N—CH₂—CH₂—CH₂— |
| 686. | OCHF₂ | (C₂H₅)₂N—CH₂—CH₂—CH₂— |
| 687. | OCHF₂ | CH₃—O—CH₂—C(CH₃)₂— |
| 688. | OCHF₂ | CH₃—S—CH₂—C(CH₃)₂— |
| 689. | OCHF₂ | CH₃—SO₂—CH₂—C(CH₃)₂— |
| 690. | OCHF₂ | C₂H₅—O—CH₂—C(CH₃)₂— |
| 691. | OCHF₂ | C₂H₅—S—CH₂—C(CH₃)₂— |
| 692. | OCHF₂ | C₂H₅—SO₂—CH₂—C(CH₃)₂— |
| 693. | OCHF₂ | (CH₃)₂N—CH₂—C(CH₃)₂— |
| 694. | OCHF₂ | (C₂H₅)₂N—CH₂—C(CH₃)₂— |
| 695. | OCHF₂ | [(CH₃)₂CH]₂N—CH₂—C(CH₃)₂— |
| 696. | OCHF₂ | Cl—CH₂—C≡C—CH₂— |
| 697. | OCHF₂ | CH₃—O—C(O)—CH₂ |
| 698. | OCHF₂ | C₂H₅—O—C(O)—CH₂ |
| 699. | OCHF₂ | CH₃—O—C(O)—CH(CH₃)— |
| 700. | OCHF₂ | C₂H₅—O—C(O)—CH(CH₃)— |
| 701. | OCHF₂ | (CH₃O)₂CH—CH₂— |
| 702. | OCHF₂ | (C₂H₅O)₂CH—CH₂— |
| 703. | OCF₃ | H |
| 704. | OCF₃ | CH₃ |
| 705. | OCF₃ | CH₃CH₂— |
| 706. | OCF₃ | (CH₃)₂CH— |
| 707. | OCF₃ | CH₃CH₂CH₂— |
| 708. | OCF₃ | n-C₄H₉ |
| 709. | OCF₃ | (CH₃)₃C— |
| 710. | OCF₃ | (CH₃)₂CH—CH₂— |
| 711. | OCF₃ | n-C₅H₁₁ |
| 712. | OCF₃ | (CH₃)₂CH—CH₂—CH₂— |
| 713. | OCF₃ | (C₂H₅)₂—CH— |
| 714. | OCF₃ | (CH₃)₃C—CH₂— |
| 715. | OCF₃ | (CH₃)₃C—CH₂—CH₂— |
| 716. | OCF₃ | C₂H₅CH(CH₃)—CH₂— |
| 717. | OCF₃ | CH₃—CH₂—C(CH₃)₂— |
| 718. | OCF₃ | (CH₃)₂CH—CH(CH₃)— |
| 719. | OCF₃ | (CH₃)₃C—CH(CH₃)— |
| 720. | OCF₃ | (CH₃)₂CH—CH₂—CH(CH₃)— |
| 721. | OCF₃ | CH₃—CH₂—C(CH₃)(C₂H₅)— |
| 722. | OCF₃ | CH₃—CH₂—CH₂—C(CH₃)₂— |
| 723. | OCF₃ | C₂H₅—CH₂—CH(CH₃)—CH₂— |
| 724. | OCF₃ | cyclopropyl |
| 725. | OCF₃ | cyclopropyl-CH₂— |
| 726. | OCF₃ | cyclopropyl-CH(CH₃)— |
| 727. | OCF₃ | cyclobutyl |
| 728. | OCF₃ | cyclopentyl |
| 729. | OCF₃ | cyclohexyl |
| 730. | OCF₃ | HC≡C—CH₂— |
| 731. | OCF₃ | HC≡C—CH(CH₃)— |
| 732. | OCF₃ | HC≡C—C(CH₃)₂— |
| 733. | OCF₃ | HC≡C—C(CH₃)(C₂H₅)— |
| 734. | OCF₃ | HC≡C—C(CH₃)(C₃H₇)— |
| 735. | OCF₃ | CH₂═CH—CH₂— |
| 736. | OCF₃ | H₂C═CH—CH(CH₃)— |
| 737. | OCF₃ | H₂C═CH—C(CH₃)₂— |
| 738. | OCF₃ | H₂C═CH—C(C₂H₅)(CH₃)— |
| 739. | OCF₃ | C₆H₅—CH₂— |
| 740. | OCF₃ | 4-(CH₃)₃C—C₆H₄—CH₂— |
| 741. | OCF₃ | C₆H₅—CH₂— |
| 742. | OCF₃ | 4-(CH₃)₃C—C₆H₄—CH₂— |
| 743. | OCF₃ | 4-Cl—C₆H₄—CH₂— |
| 744. | OCF₃ | 3-(CH₃O)—C₆H₄—CH₂— |
| 745. | OCF₃ | 4-(CH₃O)—C₆H₄—CH₂— |
| 746. | OCF₃ | 2-(CH₃O)—C₆H₄—CH₂— |
| 747. | OCF₃ | 3-Cl—C₆H₄—CH₂— |
| 748. | OCF₃ | 2-Cl—C₆H₄—CH₂— |
| 749. | OCF₃ | 4-(F₃C)—C₆H₄—CH₂— |
| 750. | OCF₃ | NC—CH₂— |
| 751. | OCF₃ | NC—CH₂—CH₂— |
| 752. | OCF₃ | NC—CH₂—CH(CH₃)— |
| 753. | OCF₃ | NC—CH₂—C(CH₃)₂— |
| 754. | OCF₃ | NC—CH₂—CH₂—CH₂— |
| 755. | OCF₃ | FH₂C—CH₂— |
| 756. | OCF₃ | ClH₂C—CH₂— |
| 757. | OCF₃ | BrH₂C—CH₂— |
| 758. | OCF₃ | FH₂C—CH(CH₃)— |
| 759. | OCF₃ | ClH₂C—CH(CH₃)— |
| 760. | OCF₃ | BrH₂C—CH(CH₃)— |
| 761. | OCF₃ | F₂HC—CH₂— |
| 762. | OCF₃ | F₃C—CH₂— |
| 763. | OCF₃ | FH₂C—CH₂—CH₂— |
| 764. | OCF₃ | ClH₂C—CH₂—CH₂— |
| 765. | OCF₃ | BrH₂C—CH₂—CH₂— |
| 766. | OCF₃ | F₂HC—CH₂—CH₂— |
| 767. | OCF₃ | F₃C—CH₂—CH₂— |
| 768. | OCF₃ | CH₃—O—CH₂—CH₂— |
| 769. | OCF₃ | CH₃—S—CH₂—CH₂— |
| 770. | OCF₃ | CH₃—SO₂—CH₂—CH₂— |
| 771. | OCF₃ | C₂H₅—O—CH₂—CH₂— |
| 772. | OCF₃ | (CH₃)₂CH—O—CH₂—CH₂— |
| 773. | OCF₃ | C₂H₅—S—CH₂—CH₂— |
| 774. | OCF₃ | C₂H₅—SO₂—CH₂—CH₂— |
| 775. | OCF₃ | (CH₃)₂N—CH₂—CH₂— |
| 776. | OCF₃ | (C₂H₅)₂N—CH₂—CH₂— |
| 777. | OCF₃ | [(CH₃)₂CH]₂N—CH₂—CH₂— |
| 778. | OCF₃ | CH₃—O—CH₂—CH(CH₃)— |
| 779. | OCF₃ | CH₃—S—CH₂—CH(CH₃)— |
| 780. | OCF₃ | CH₃—SO₂—CH₂—CH(CH₃)— |
| 781. | OCF₃ | C₂H₅—O—CH₂—CH(CH₃)— |
| 782. | OCF₃ | C₂H₅—S—CH₂—CH(CH₃)— |
| 783. | OCF₃ | C₂H₅—SO₂—CH₂—CH(CH₃)— |
| 784. | OCF₃ | (CH₃)₂N—CH₂—CH(CH₃)— |
| 785. | OCF₃ | (C₂H₅)₂N—CH₂—CH(CH₃)— |
| 786. | OCF₃ | [(CH₃)₂CH]₂N—CH₂—CH(CH₃)— |
| 787. | OCF₃ | CH₃—O—CH(CH₃)—CH₂— |
| 788. | OCF₃ | CH₃—S—CH(CH₃)—CH₂— |
| 789. | OCF₃ | CH₃—SO₂—CH(CH₃)—CH₂— |
| 790. | OCF₃ | C₂H₅—O—CH(CH₃)—CH₂— |
| 791. | OCF₃ | C₂H₅—S—CH(CH₃)—CH₂— |
| 792. | OCF₃ | C₂H₅—SO₂—CH(CH₃)—CH₂— |
| 793. | OCF₃ | (CH₃)₂N—CH(CH₃)—CH₂— |
| 794. | OCF₃ | (C₂H₅)₂N—CH(CH₃)—CH₂— |
| 795. | OCF₃ | [(CH₃)₂CH]₂N—CH(CH₃)—CH₂— |
| 796. | OCF₃ | CH₃—O—CH₂—CH₂—CH₂— |
| 797. | OCF₃ | CH₃—S—CH₂—CH₂—CH₂— |
| 798. | OCF₃ | CH₃—SO₂—CH₂—CH₂—CH₂— |
| 799. | OCF₃ | C₂H₅—O—CH₂—CH₂—CH₂— |
| 800. | OCF₃ | C₂H₅—S—CH₂—CH₂—CH₂— |
| 801. | OCF₃ | C₂H₅—SO₂—CH₂—CH₂—CH₂— |
| 802. | OCF₃ | (CH₃)₂N—CH₂—CH₂—CH₂— |
| 803. | OCF₃ | (C₂H₅)₂N—CH₂—CH₂—CH₂— |
| 804. | OCF₃ | CH₃—O—CH₂—C(CH₃)₂— |
| 805. | OCF₃ | CH₃—S—CH₂—C(CH₃)₂— |
| 806. | OCF₃ | CH₃—SO₂—CH₂—C(CH₃)₂— |
| 807. | OCF₃ | C₂H₅—O—CH₂—C(CH₃)₂— |
| 808. | OCF₃ | C₂H₅—S—CH₂—C(CH₃)₂— |
| 809. | OCF₃ | C₂H₅—SO₂—CH₂—C(CH₃)₂— |
| 810. | OCF₃ | (CH₃)₂N—CH₂—C(CH₃)₂— |
| 811. | OCF₃ | (C₂H₅)₂N—CH₂—C(CH₃)₂— |
| 812. | OCF₃ | [(CH₃)₂CH]₂N—CH₂—C(CH₃)₂— |
| 813. | OCF₃ | Cl—CH₂—C≡C—CH₂— |
| 814. | OCF₃ | CH₃—O—C(O)—CH₂ |
| 815. | OCF₃ | C₂H₅—O—C(O)—CH₂ |
| 816. | OCF₃ | CH₃—O—C(O)—CH(CH₃)— |
| 817. | OCF₃ | C₂H₅—O—C(O)—CH(CH₃)— |
| 818. | OCF₃ | (CH₃O)₂CH—CH₂— |
| 819. | OCF₃ | (C₂H₅O)₂CH—CH₂— |
| 820. | OCClF₂ | H |
| 821. | OCClF₂ | CH₃ |
| 822. | OCClF₂ | CH₃CH₂— |
| 823. | OCClF₂ | (CH₃)₂CH— |
| 824. | OCClF₂ | CH₃CH₂CH₂— |
| 825. | OCClF₂ | n-C₄H₉ |
| 826. | OCClF₂ | (CH₃)₃C— |
| 827. | OCClF₂ | (CH₃)₂CH—CH₂— |
| 828. | OCClF₂ | n-C₅H₁₁ |
| 829. | OCClF₂ | (CH₃)₂CH—CH₂—CH₂— |
| 830. | OCClF₂ | (C₂H₅)₂—CH— |
| 831. | OCClF₂ | (CH₃)₃C—CH₂— |
| 832. | OCClF₂ | (CH₃)₃C—CH₂—CH₂— |
| 833. | OCClF₂ | C₂H₅CH(CH₃)—CH₂— |
| 834. | OCClF₂ | CH₃—CH₂—C(CH₃)₂— |
| 835. | OCClF₂ | (CH₃)₂CH—CH(CH₃)— |
| 836. | OCClF₂ | (CH₃)₃C—CH(CH₃)— |
| 837. | OCClF₂ | (CH₃)₂CH—CH₂—CH(CH₃)— |
| 838. | OCClF₂ | CH₃—CH₂—C(CH₃)(C₂H₅)— |
| 839. | OCClF₂ | CH₃—CH₂—CH₂—C(CH₃)₂— |
| 840. | OCClF₂ | C₂H₅—CH₂—CH(CH₃)—CH₂— |
| 841. | OCClF₂ | cyclopropyl |
| 842. | OCClF₂ | cyclopropyl-CH₂— |
| 843. | OCClF₂ | cyclopropyl-CH(CH₃)— |
| 844. | OCClF₂ | cyclobutyl |
| 845. | OCClF₂ | cyclopentyl |
| 846. | OCClF₂ | cyclohexyl |
| 847. | OCClF₂ | HC≡C—CH₂— |
| 848. | OCClF₂ | HC≡C—CH(CH₃)— |
| 849. | OCClF₂ | HC≡C—C(CH₃)₂— |
| 850. | OCClF₂ | HC≡C—C(CH₃)(C₂H₅)— |
| 851. | OCClF₂ | HC≡C—C(CH₃)(C₃H₇)— |
| 852. | OCClF₂ | CH₂═CH—CH₂— |
| 853. | OCClF₂ | H₂C═CH—CH(CH₃)— |
| 854. | OCClF₂ | H₂C═CH—C(CH₃)₂— |
| 855. | OCClF₂ | H₂C═CH—C(C₂H₅)(CH₃)— |
| 856. | OCClF₂ | C₆H₅—CH₂— |
| 857. | OCClF₂ | 4-(CH₃)₃C—C₆H₄—CH₂— |
| 858. | OCClF₂ | C₆H₅—CH₂— |
| 859. | OCClF₂ | 4-(CH₃)₃C—C₆H₄—CH₂— |
| 860. | OCClF₂ | 4-Cl—C₆H₄—CH₂— |
| 861. | OCClF₂ | 3-(CH₃O)—C₆H₄—CH₂— |
| 862. | OCClF₂ | 4-(CH₃O)—C₆H₄—CH₂— |
| 863. | OCClF₂ | 2-(CH₃O)—C₆H₄—CH₂— |
| 864. | OCClF₂ | 3-Cl—C₆H₄—CH₂— |
| 865. | OCClF₂ | 2-Cl—C₆H₄—CH₂— |
| 866. | OCClF₂ | 4-(F₃C)—C₆H₄—CH₂— |
| 867. | OCClF₂ | NC—CH₂— |
| 868. | OCClF₂ | NC—CH₂—CH₂— |
| 869. | OCClF₂ | NC—CH₂—CH(CH₃)— |
| 870. | OCClF₂ | NC—CH₂—C(CH₃)₂— |
| 871. | OCClF₂ | NC—CH₂—CH₂—CH₂— |
| 872. | OCClF₂ | FH₂C—CH₂— |
| 873. | OCClF₂ | ClH₂C—CH₂— |
| 874. | OCClF₂ | BrH₂C—CH₂— |
| 875. | OCClF₂ | FH₂C—CH(CH₃)— |
| 876. | OCClF₂ | ClH₂C—CH(CH₃)— |
| 877. | OCClF₂ | BrH₂C—CH(CH₃)— |
| 878. | OCClF₂ | F₂HC—CH₂— |
| 879. | OCClF₂ | F₃C—CH₂— |
| 880. | OCClF₂ | FH₂C—CH₂—CH₂— |
| 881. | OCClF₂ | ClH₂C—CH₂—CH₂— |
| 882. | OCClF₂ | BrH₂C—CH₂—CH₂— |
| 883. | OCClF₂ | F₂HC—CH₂—CH₂— |
| 884. | OCClF₂ | F₃C—CH₂—CH₂— |
| 885. | OCClF₂ | CH₃—O—CH₂—CH₂— |
| 886. | OCClF₂ | CH₃—S—CH₂—CH₂— |
| 887. | OCClF₂ | CH₃—SO₂—CH₂—CH₂— |
| 888. | OCClF₂ | C₂H₅—O—CH₂—CH₂— |
| 889. | OCClF₂ | (CH₃)₂CH—O—CH₂—CH₂— |
| 890. | OCClF₂ | C₂H₅—S—CH₂—CH₂— |
| 891. | OCClF₂ | C₂H₅—SO₂—CH₂—CH₂— |
| 892. | OCClF₂ | (CH₃)₂N—CH₂—CH₂— |
| 893. | OCClF₂ | (C₂H₅)₂N—CH₂—CH₂— |
| 894. | OCClF₂ | [(CH₃)₂CH]₂N—CH₂—CH₂— |
| 895. | OCClF₂ | CH₃—O—CH₂—CH(CH₃)— |
| 896. | OCClF₂ | CH₃—S—CH₂—CH(CH₃)— |
| 897. | OCClF₂ | CH₃—SO₂—CH₂—CH(CH₃)— |
| 898. | OCClF₂ | C₂H₅—O—CH₂—CH(CH₃)— |
| 899. | OCClF₂ | C₂H₅—S—CH₂—CH(CH₃)— |
| 900. | OCClF₂ | C₂H₅—SO₂—CH₂—CH(CH₃)— |
| 901. | OCClF₂ | (CH₃)₂N—CH₂—CH(CH₃)— |
| 902. | OCClF₂ | (C₂H₅)₂N—CH₂—CH(CH₃)— |
| 903. | OCClF₂ | [(CH₃)₂CH]₂N—CH₂—CH(CH₃)— |
| 904. | OCClF₂ | CH₃—O—CH(CH₃)—CH₂— |
| 905. | OCClF₂ | CH₃—S—CH(CH₃)—CH₂— |
| 906. | OCClF₂ | CH₃—SO₂—CH(CH₃)—CH₂— |
| 907. | OCClF₂ | C₂H₅—O—CH(CH₃)—CH₂— |
| 908. | OCClF₂ | C₂H₅—S—CH(CH₃)—CH₂— |
| 909. | OCClF₂ | C₂H₅—SO₂—CH(CH₃)—CH₂— |
| 910. | OCClF₂ | (CH₃)₂N—CH(CH₃)—CH₂— |
| 911. | OCClF₂ | (C₂H₅)₂N—CH(CH₃)—CH₂— |
| 912. | OCClF₂ | [(CH₃)₂CH]₂N—CH(CH₃)—CH₂— |
| 913. | OCClF₂ | CH₃—O—CH₂—CH₂—CH₂— |
| 914. | OCClF₂ | CH₃—S—CH₂—CH₂—CH₂— |
| 915. | OCClF₂ | CH₃—SO₂—CH₂—CH₂—CH₂— |
| 916. | OCClF₂ | C₂H₅—O—CH₂—CH₂—CH₂— |
| 917. | OCClF₂ | C₂H₅—S—CH₂—CH₂—CH₂— |
| 918. | OCClF₂ | C₂H₅—SO₂—CH₂—CH₂—CH₂— |
| 919. | OCClF₂ | (CH₃)₂N—CH₂—CH₂—CH₂— |
| 920. | OCClF₂ | (C₂H₅)₂N—CH₂—CH₂—CH₂— |
| 921. | OCClF₂ | CH₃—O—CH₂—C(CH₃)₂— |
| 922. | OCClF₂ | CH₃—S—CH₂—C(CH₃)₂— |
| 923. | OCClF₂ | CH₃—SO₂—CH₂—C(CH₃)₂— |
| 924. | OCClF₂ | C₂H₅—O—CH₂—C(CH₃)₂— |
| 925. | OCClF₂ | C₂H₅—S—CH₂—C(CH₃)₂— |
| 926. | OCClF₂ | C₂H₅—SO₂—CH₂—C(CH₃)₂— |
| 927. | OCClF₂ | (CH₃)₂N—CH₂—C(CH₃)₂— |
| 928. | OCClF₂ | (C₂H₅)₂N—CH₂—C(CH₃)₂— |
| 929. | OCClF₂ | [(CH₃)₂CH]₂N—CH₂—C(CH₃)₂— |
| 930. | OCClF₂ | Cl—CH₂—C≡C—CH₂— |
| 931. | OCClF₂ | CH₃—O—C(O)—CH₂ |
| 932. | OCClF₂ | C₂H₅—O—C(O)—CH₂ |
| 933. | OCClF₂ | CH₃—O—C(O)—CH(CH₃)— |
| 934. | OCClF₂ | C₂H₅—O—C(O)—CH(CH₃)— |
| 935. | OCClF₂ | (CH₃O)₂CH—CH₂— |
| 936. | OCClF₂ | (C₂H₅O)₂CH—CH₂— |

The 2-cyanobenzenesulfonamide compounds of the formula I can be prepared, for example, by reacting a 2-cyanobenzenesulfonylhalide II with ammonia or a primary amine (III), similarly to a process described in J. March, 4^{th} edition 1992, p. 499 (see Scheme 1).

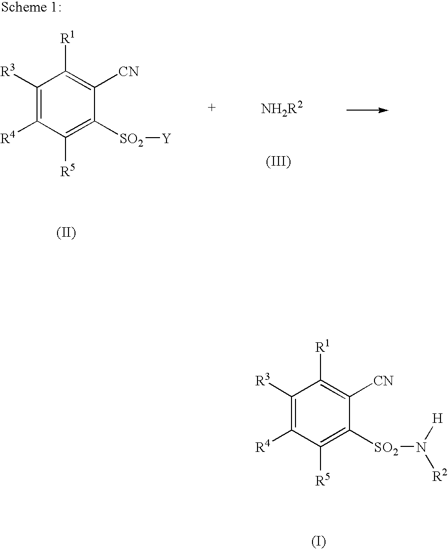

In Scheme 1 the variables R¹ to R⁵ are as defined above and Y is halogen, especially chlorine or bromine. The reaction of a sulfonylhalide II, especially a sulfonylchloride, with an amine III is usually carried out in the presence of a solvent. Suitable solvents are polar solvents which are inert under the reaction conditions, for example C₁-C₄-alkanols such as methanol, ethanol, n-propanol or isopropanol, dialkyl ethers such as diethyl ether, diisopropyl ether or methyl tert-butyl ether, cyclic ethers such as dioxane or tetrahydrofuran, acetonitrile, carboxamides such as N,N-dimethyl formamide, N,N-dimethyl acetamide or N-methylpyrrolidinone, water, (provided the sulfonylhalide II is sufficiently resistant to hydrolysis under the reaction conditions used) or a mixture thereof.

In general, the amine III is employed in an at least equimolar amount, preferably at least 2-fold molar excess, based on the sulfonylhalide II, to bind the hydrogen halide formed. It may be advantageous to employ the primary amine III in an up to 6-fold molar excess, based on the sulfonylhalide II.

It may be advantageous to carry out the reaction in the presence of an auxiliary base. Suitable auxiliary bases include organic bases, for example tertiary amines, such as aliphatic tertiary amines, such as trimethylamine, triethylamine or diisopropylamine, cycloaliphatic tertiary amines such as N-methylpiperidine or aromatic amines such pyridine, substituted pyridines such as 2,3,5-collidine, 2,4,6-collidine, 2,4-lutidine, 3,5-lutidine or 2,6-lutidine and inorganic bases for example alkali metal carbonates and alkaline earth metal carbonates such as lithium carbonate, potassium carbonate and sodium carbonate, calcium carbonate and alkaline metal hydrogencarbonates such as sodium hydrogen carbonate. The molar ratio of auxiliary base to sulfonylhalide II is preferably in the range of from 1:1 to 4:1, preferably 1:1 to 2:1. If the reaction is carried out in the presence of an auxiliary base, the molar ratio of primary amine III to sulfonylhalide II usually is 1:1 to 1.5:1.

The reaction is usually carried out at a reaction temperature ranging from 0° C. to the boiling point of the solvent, preferably from 0 to 30° C.

If not commercially available, the sulfonylhalide compounds II may be prepared, for example by one of the processes as described below.

The preparation of the sulfonylchloride compound II can be carried out, for example, according to the reaction sequence shown in Scheme 2 where the variables R¹, R³ to R⁵ are as defined above: 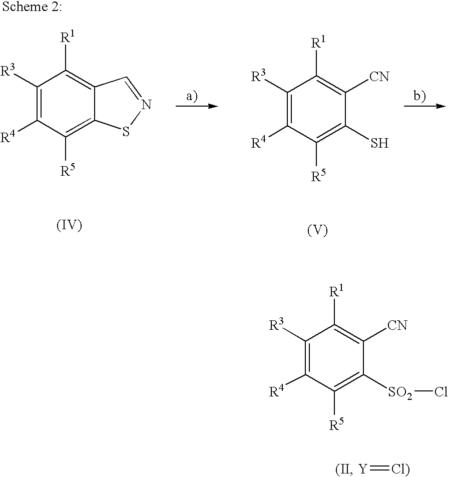
a) conversion of a benzisothiazole IV to a thiol V, for example, in analogy to a process described in Liebigs Ann. Chem. 1980, 768-778, by reacting IV with a base such as an alkali metal hydroxide and alkaline earth metal hydroxide such as sodium hydroxide, potassium hydroxide and calcium hydroxide, an alkali metal hydride such as sodium hydride or potassium hydride or an alkoxide such as sodium methoxide, sodium ethoxide and the like in an inert organic solvent, for example an ether such as diethyl ether, diisopropyl ether, tetrahydrofuran, dioxane, or in a alcohol such as methanol, ethanol, propanol, isopropanol, butanol, 1,2-ethanediol, diethylene glycol, or in a carboxamide such as N,N-dimethyl form amide, N,N-dimethyl acetamide or N-methylpyrrolidinone or in dimethylsulfoxide or in a mixture of the above mentioned solvents; and acidification to yield the thiol V. The benzisothiazole IV can be prepared in analogy to a process described in Liebig Ann. Chem 729, 146-151 (1969); and subsequent
b) oxidation of the thiol V to the sulfonylchloride II (Y═Cl), for example, by reacting the thiol V with chlorine in water or a water-solvent mixture, e.g. a mixture of water and acetic acid, in analogy to a process described in Jerry March, 3^{rd} edition, 1985, reaction 9-27, page 1087.

Compounds II (where Y is chlorine and R⁴ and R⁵ are hydrogen) may be prepared by the reaction sequence shown in Scheme 3 where the variable R¹ has the meanings given above and R³ is H, Cl, Br, I or CN: 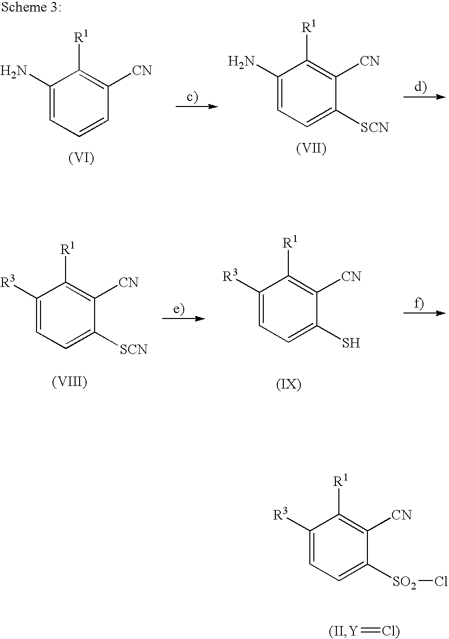
c) preparing a thiocyanato compound VII by thiocyanation of the aniline VI with thiocyanogen, for example, in analogy to a process described in EP 945 449, in Jerry March, 3^{rd} edition, 1985, p. 476, in Neuere Methoden der organischen Chemie, Vol. 1, 237 (1944) or in J. L. Wood, Organic Reactions, vol. III, 240 (1946); the thiocyanogen is usually prepared in situ by reacting, for example, sodium thiocyanate with bromine in an inert solvent. Suitable solvents include alkanols such as methanol or ethanol or carboxylic acids such as acetic acid, propionic acid or isobutyric acid and mixtures thereof. Preferably, the inert solvent is methanol to which some sodium bromide may have been added for stabilization.
d) conversion of the amino group in VII into a diazonium group by a conventional diazotation followed by conversion of the diazonium group into hydrogen, chlorine, bromine or iodine or cyano. Suitable nitrosating agents are nitrosonium tetrafluoroborate, nitrosyl chloride, nitrosyl sulfuric acid, alkyl nitrites such as tbutyl nitrite, or salts of nitrous acid such as sodium nitrite. The conversion of the resulting diazonium salt into the corresponding compound VIII where R³=cyano, chlorine, bromine or iodine may be carried out by treatment of VII with a solution or suspension of a copper(I) salt, such as copper(I) cyanide, chloride, bromide or iodide or with a solution of an alkali metal salt (cf., for example, Houben-Weyl, Methoden der organischen Chemie [Methods of Organic Chemistry], Georg Thieme Verlag Stuttgart, Vol. 5/4, 4^{th} edition 1960, p. 438 ff.) The conversion of the resulting diazonium salt into the corresponding compound VIII where R³═H, for example, may be carried out by treatment with hypophosphorous acid, phosphorous acid, sodium stannite or in non-aqueous media by treatment with tributyltin hydride or (C₂H₅)₃SnH or with sodium borohydride (cf., for example, Jerry March, 3^{rd} edition, 1985, 646f).
e) reduction of the thiocyanate VIII to the corresponding thiol compound IX by treatment with zinc in the presence of sulfuric acid or by treatment with sodium sulfide; and subsequent
f) oxidation of the thiol IX to obtain the sulfonylchloride II in analogy to step b) of scheme 2.

Furthermore, the benzenesulfonylchloride II (Y═Cl) may be prepared by the reaction sequence shown in Scheme 4 where the variables R¹, R³, R⁴ and R⁵ are as defined above. 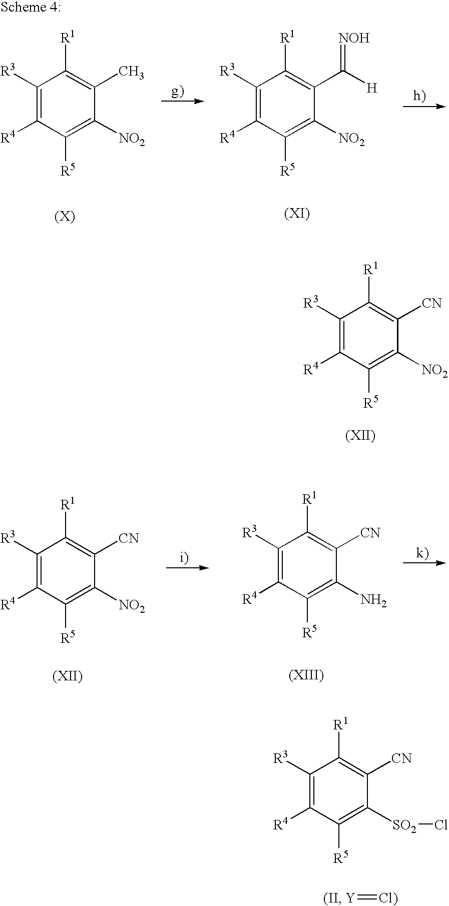
(g) transformation of nitrotoluene X into the benzaldoxime compound XI, for example in analogy to a process described in WO 00/29394. The transformation of X into XI is e.g. achieved by reacting nitro compound X with an organic nitrite R—ONO, wherein R is alkyl in the presence of a base. Suitable nitrites are C₂-C₈-alkyl nitrites such as n-butyl nitrite or (iso)amyl nitrite. Suitable bases are alkali metal alkoxides such as sodium methoxide, potassium methoxide or potassium tertbutoxide, alkali metal hydroxides such as NaOH or KOH or organo magnesium compounds such as Grignard reagents of the formula R′MgX (R′=alkyl, X=halogen). The reaction is usually carried out in an inert solvent, which preferably comprises a polar aprotic solvent. Suitable polar aprotic solvents include carboxamides such as N,N-dialkylformamides, e.g. N,N-dimethylformamide, N,N-dialkylacetamides, e.g. N,N-dimethylacetamide or N-alkyllactames e.g. N-methylpyrrolidone or mixtures thereof or mixtures thereof with non-polar solvents such as alkanes, cycloalkanes and aromatic solvents e.g. toluene and xylenes. When using sodium bases, 1-10 mol % of an alcohol may be added, if appropriate. The stoichiometric ratios are, for example, as follows: 1-4 equivalents of base, 1-2 equivalents of R—ONO; preferably 1.5-2.5 equivalents of base and 1-1.3 equivalents of R—ONO; equally preferably: 1-2 equivalents of base and 1-1.3 equivalents of R—ONO. The reaction is usually carried out in the range from −60° C. to room temperature, preferably −50° C. to −20° C., in particular from −35° C. to −25° C.
(h) dehydration of the aldoxime XI to the nitrile XII, for example by treatment with a dehydrating agent such as acetic anhydride, ethyl orthoformate and H⁺, (C₆H₅)₃P—CCl₄, trichloromethyl chloroformate, methyl (or ethyl)cyanoformate, trifluoromethane sulfonic anhydride in analogy to a procedure described in Jerry March, 4^{th} edition, 1992, 1038f;
(i) reduction of compound XII to the aniline XIII, for example by reacting the nitro compound XII with a metal, such as iron, zinc or fin or with SnCl₂, under acidic conditions, with a complex hydride, such as lithium aluminium hydride and sodium. The reduction may be carried out without dilution or in a solvent or diluent. Suitable solvents are—depending on the reduction reagent chosen—for example water, alkanols, such as methanol, ethanol and isopropanol, or ethers, such as diethyl ether, methyl tert-butyl ether, dioxane, tetrahydrofuran and ethylene glycol dimethyl ether.
   The nitro group in compound XII may also be converted into an amino group by catalytic hydrogenation (see, for example, Houben Weyl, Vol. IV/1c, p. 506 ff or WO 00/29394). Catalysts being suitable are, for example, platinum or palladium catalysts, wherein the metal may be supported on an inert carrier such as activated carbon, clays, celithe, silica, alumina, alkaline or earth alkaline carbonates etc. The metal content of the catalyst may vary from 1 to 20% by weight, based on the support. In general, from 0.001 to 1% by weight of platinum or palladium, based on the nitro compound XII, preferably from 0.01 to 1% by weight of platinum or palladium are used. The reaction is usually carried out either without a solvent or in an inert solvent or diluent. Suitable solvents or diluents include aromatics such as benzene, toluene, xylenes, carboxamides such as N,N-dialkylformamides, e.g. N,N-dimethylformamide, N,N-dialkylacetamides, e.g. N,N-dimethylacetamide or N-alkyl lactames e.g. N-methylpyrrolidone, tetraalkylureas, such as tetramethylurea, tetrabutylurea, N,N′-dimethylpropylene urea and N,N′-dimethylethylene urea, alkanols such as methanol, ethanol, isopropanol, or n-butanol, ethers, such as diethyl ether, methyl tert-butyl ether, dioxane, tetrahydrofuran and ethylene glycol dimethyl ether, carboxylic acids such as acetic acid or propionic acid, carbonic acid ester such as ethyl acetate. The reaction temperature is usually in the range from −20° C. to 100° C., preferably 0° C. to 50° C. The hydrogenation may be carried out under atmospheric hydrogen pressure or elevated hydrogen pressure.
(k) conversion of the amino group of compound XIII into the corresponding diazonium group followed by reacting the diazonium salt with sulfur dioxide in the presence of copper(II) chloride to afford the sulfonylchloride II. The diazonium salt may be prepared as described in step d) of scheme 3. Preferably, sodium nitrite is used as alkyl nitrite. In general, the sulfur dioxide is dissolved in glacial acetic acid.

The compounds of formula XIII may also be prepared according to methods described in WO 94/18980 using ortho-nitroanilines as precursors or WO 00/059868 using isatin precursors.

If individual compounds cannot be obtained via the above-described routes, they can be prepared by derivatization other compounds I or by customary modifications of the synthesis routes described.

The reaction mixtures are worked up in the customary manner, for example by mixing with water, separating the phases and, if appropriate, purifying the crude products by chromatography, for example on alumina or silica gel may be employed. Some of the intermediates and end products may be obtained in the form of colorless or pale brown viscous oils which are freed or purified form volatile components under reduced pressure and at moderately elevated temperature. If the intermediates and end products are obtained as solids, they may be purified by recrystallisation or digestion.

Due to their excellent activity, the compounds of the general formula I may be used for controlling animal pests. Animal pests include harmful insects and acaridae. Accordingly, the invention further provides agriculturally composition for combating animal pests, especially insects and/or acaridae which comprises such an amount of at least one compound of the general formula I and/or at least one agriculturally useful salt of I and at least one inert liquid and/or solid agronomically acceptable carrier that it has a pesticidal action and, if desired, at least one surfactant.

Such a composition may contain a single active compound of the general formula I or a mixture of several active compounds I according to the present invention. The composition according to the present invention may comprise an individual isomer or mixtures of isomers.

The 2-cyanobenzenesulfonamide compounds I and the pestidicidal compositions comprising them are effective agents for controlling animal pests. Animal pests controlled by the compounds of formula I include for example:

insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandioseila, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibemia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis;

beetles (Coleoptera), for example Agrilus sinuatus, Agriotes lineatus, Agriotes obscurus, Amphimallus solstitialis, Anisandrus dispar, Anthonomus grandis, Anthonomus pomorum, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus, Crioceris asparagi, Diabrotica longicomis, Diabrotica 12-punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllotreta chrysocephala, Phyllophaga sp., Phyllopertha horticola, Phyllotreta nemorum, Phyllotreta striolata, Popillia japonica, Sitona lineatus and Sitophilus granaria;

dipterans (Diptera), for example Aedes aegypti, Aedes vexans, Anastrepha ludens, Anopheles maculipennis, Ceratitis capitata, Chrysomya bezziana, Chrysomya hominivorax, Chrysomya macellaria, Contarinia sorghicola, Cordylobia anthropophaga, Culex pipiens, Dacus cucurbitae, Dacus oleae, Dasineura brassicae, Fannia canicularis, Gasterophilus intestinalis, Glossina morsitans, Haematobia irritans, Haplodiplosis equestris, Hylemyia platura, Hypoderma lineata, Liriomyza sativae, Liriomyza trifolii, Lucilia caprina, Lucilia cuprina, Lucilia sericata, Lycoda pectorals, Mayetiola destructor, Musca domestica, Muscina stabulans, Oestrus ovis, Oscinella frit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa;

thrips (Thysanoptera), e.g. Dichromothrips corbetti, Frankliniella fusca, Frankliniella occidentalis, Frankliniella tritici, Scirtothrips citri, Thrips oryzae, Thrips palmi and Thrips tabaci;

hymenopterans (Hymenoptera) such as ants, bees, wasps and sawflies, e.g. Athalia rosae, Atta cephalotes, Atta sexdens, Atta texana, Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex californicus, Dasymutilla occidentalis, Bombus spp., Vespula squamosa, Paravespula vulgaris, Paravespula pennsylvanica, Paravespula gemmanica, Dolichovespula maculata, Vespa crabro, Polistes, rubiginosa, Campodontus floridanus, and Linepitheum humile (Linepithema humile);

heteropterans (Heteroptera), e.g. Acrostemum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis and Thyanta perditor;

homopterans (Homoptera), e.g. Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi, Brachycaudus persicae, Brachycaudus prunicola, Brevicoryne brassicae, Capitophorus homi, Cerosipha gossypli, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus persicae, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Sogatella furcifera Trialeurodes vaporariorum, Toxoptera aurantiiand, and Viteus vitifolii;

termites (Isoptera), e.g. Calotermes flavicollis, Leucotermes flavipes, Reticulitermes flavipes, Reticulitermes lucifugus und Termes natalensis;

orthopterans (Orthoptera), e.g. Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus;

Arachrnoidea, such as arachnids (Acarina), e.g. of the families Argasidae, Ixodidae and Sarcoptidae, such as Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Omithodorus moubata; Otobius megnini, Dermanyssus gallinae, Psoroptes ovis, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telanus and Tetranychus urticae, Panonychus ulmi, Panonychus citn, and oligonychus pratensis;

Siphonatera, e.g. Xenopsylla cheopsis, Ceratophyllus spp.

The compounds of the formula I are preferably used for controlling pests of the orders Homoptera and Thysanoptera.

The compounds of the formula I are also preferably used for controlling pests of the orders Hymenoptera.

The compounds of formula (I) or the pesticidal compositions comprising them may be used to protect growing plants and crops from attack or infestation by animal pests, especially insects or acaridae by contacting the plant/crop with a pesticidally effective amount of compounds of formula (I). The term “crop” refers both to growing and harvested crops.

The animal pest, especially the insect, acaridae, plant and/or soil or water in which the plant is growing can be contacted with the present compound(s) I or composition(s) containing them by any application method known in the art. As such, “contacting” includes both direct contact (applying the compounds/compositions directly on the animal pest, especially the insect and/or acaridae, and/or plant—typically to the foliage, stem or roots of the plant) and indirect contact (applying the compounds/compositions to the locus of the animal pest, especially the insect and/or acaridae, and/or plant).

Moreover, animal pests, especially insects or acaridae may be controlled by contacting the target pest, its food supply or its locus with a pesticidally effective amount of compounds of formula (I). As such, the application may be carried out before or after the infection of the locus, growing crops, or harvested crops by the pest.

“Locus” means a habitat, breeding ground, plant, seed, soil, area, material or environment in which a pest or parasite is growing or may grow.

Effective amounts suitable for use in the method of invention may vary depending upon the particular formula I compound, target pest, method of application, application timing, weather conditions, animal pest habitat, especially insect, or acarid habitat, or the like. In general, for use in treating crop plants, the rate of application of the compounds I and/or compositions according to this invention may be in the range of about 0.1 g to about 4000 g per hectare, desirably from about 25 g to about 600 g per hectare, more desirably from about 50 g to about 500 g per hectare. For use in treating seeds, the typical rate of application is of from about 1 g to about 500 g per kilogram of seeds, desirably from about 2 g to about 300 g per kilogram of seeds, more desirably from about 10 g to about 200 g per kilogram of seeds. Customary application rates in the protection of materials are, for example, from about 0.001 g to about 2000 g, desirably from about 0.005 g to about 1000 g, of active compound per cubic meter of treated material.

The compounds I or the pesticidal compositions comprising them can be used, for example in the form of solutions, emulsions, microemulsions, suspensions, flowable concentrates, dusts, powders, pastes and granules. The use form depends on the particular purpose; in any case, it should guarantee a fine and uniform distribution of the compound according to the invention.

The pesticidal composition for combating animal pests, especially insects and/or acaridae contains such an amount of at least one compound of the general formula I or an agriculturally useful salt of I and auxiliaries which are usually used in formulating pesticidal composition.

The formulations are prepared in a known manner, e.g. by extending the active ingredient with solvents and/or carriers, if desired using emulsifiers and dispersants, it also being possible to use other organic solvents as auxiliary solvents if water is used as the diluent. Auxiliaries which are suitable are essentially: solvents such as aromatics (e.g. xylene), chlorinated aromatics (e.g. chlorobenzenes), paraffins (e.g. mineral oil fractions), alcohols (e.g. methanol, butanol), ketones (e.g. cyclohexanone), amines (e.g. ethanolamine, dimethylformamide) and water; carriers such as ground natural minerals (e.g. kaolins, clays, talc, chalk) and ground synthetic minerals (e.g. highly-disperse silica, silicates); emulsifiers such as non-ionic and anionic emulsifiers (e.g. polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of ligno-sulfonic acid, naphthalenesulfonic acid, phenolsulfonic acid, dibutylnaphthalenesulfonic acid, alkylarylsulfonates, alkyl sulfates, alkylsulfonates, fatty alcohol sulfates and fatty acids and their alkali metal and alkaline earth metal salts, salts of sulfated fatty alcohol glycol ether, condensates of sulfonated naphthalene and naphthalene derivatives with formaldehyde, condensates of naphthalene or of napthalenesulfonic acid with phenol or formaldehyde, polyoxyethylene octylphenyl ether, ethoxylated isooctylphenol, octylphenol, nonylphenol, alkylphenol polyglycol ethers, tributylphenyl polyglycol ethers, alkylaryl polyether alcohols, isotridecyl alcohol, fatty alcohoVethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphiatic, cyclic and aromatic hydrocarbons, e.g. benzene, toluene, xylene, paraffin, tetrahydronaphthalene, alkylated naphthalenes or their derivatives, methanol, ethanol, propanol, butanol, chloroform, carbon tetrachloride, cyclohexanol, cyclohexanone, chlorobenzene, isophorone, strongly polar solvents, e.g. dimethylformamide, dimethyl sulfoxide, N-methylpyrrolidone and water.

Powders, materials for scattering and dusts can be prepared by mixing or concomitantly grinding the active substances with a solid carrier.

Granules, e.g. coated granules, compacted granules, impregnated granules and homogeneous granules, can be prepared by binding the active ingredients to solid carriers. Examples of solid carriers are mineral earths, such as silicas, silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, e.g. ammonium sulfate, ammonium phosphate, ammonium nitrate, ureas, and products of vegetable origin, such as cereal meal, tree bark meal, wood meal and nutshell meal, cellulose powders and other solid carriers.

Such formulations or compositions of the present invention include a formula I compound of this invention (or combinations thereof) admixed with one or more agronomically acceptable inert, solid or liquid carriers. Those compositions contain a pesticidally effective amount of said compound or compounds, which amount may vary depending upon the particular compound, target pest, and method of use.

In general, the formulations comprise of from 0.01 to 95% by weight, preferably from 0.1 to 90% by weight, of the active ingredient. The active ingredients are employed in a purity of from 90% to 100%, preferably 95% to 100% (according to NMR spectrum).

The following are exemplary formulations:
I. 5 parts by weight of a compound according to the invention are mixed intimately with 95 parts by weight of finely divided kaolin. This gives a dust which comprises 5% by weight of the active ingredient.
II. 30 parts by weight of a compound according to the invention are mixed intimately with a mixture of 92 parts by weight of pulverulent silica gel and 8 parts by weight of paraffin oil which had been sprayed onto the surface of this silica gel. This gives a formulation of the active ingredient with good adhesion properties (comprises 23% by weight of active ingredient).
III. 10 parts by weight of a compound according to the invention are dissolved in a mixture composed of 90 parts by weight of xylene, 6 parts by weight of the adduct of 8 to 10 mol of ethylene oxide and 1 mol of oleic acid N-monoethanolamide, 2 parts by weight of calcium dodecylbenzenesulfonate and 2 parts by weight of the adduct of 40 mol of ethylene oxide and 1 mol of castor oil (comprises 9% by weight of active ingredient).
IV. 20 parts by weight of a compound according to the invention are dissolved in a mixture composed of 60 parts by weight of cyclohexanone, 30 parts by weight of isobutanol, 5 parts by weight of the adduct of 7 mol of ethylene oxide and 1 mol of isooctylphenol and 5 parts by weight of the adduct of 40 mol of ethylene oxide and 1 mol of castor oil (comprises 16% by weight of active ingredient).
V. 80 parts by weight of a compound according to the invention are mixed thoroughly with 3 parts by weight of sodium diisobutyinaphthalene-alpha-sulfonate, 10 parts by weight of the sodium salt of a lignosulfonic acid from a sulfite waste liquor and 7 parts by weight of pulverulent silica gel, and the mixture is ground in a hammer mill (comprises 80% by weight of active ingredient).
VI. 90 parts by weight of a compound according to the invention are mixed with 10 parts by weight of N-methyl-α-pyrrolidone, which gives a solution which is suitable for use in the form of microdrops (comprises 90% by weight of active ingredient).
VII. 20 parts by weight of a compound according to the invention are dissolved in a mixture composed of 40 parts by weight of cyclohexanone, 30 parts by weight of isobutanol, 20 parts by weight of the adduct of 7 mol of ethylene oxide and 1 mol of isooctylphenol and 10 parts by weight of the adduct of 40 mol of ethylene oxide and 1 mol of castor oil. Pouring the solution into 100,000 parts by weight of water and finely distributing it therein gives an aqueous dispersion which comprises 0.02% by weight of the active ingredient.
VIII. 20 parts by weight of a compound according to the invention are mixed thoroughly with 3 parts by weight of sodium diisobutylnaphthalene-α-sulfonate, 17 parts by weight of the sodium salt of a lignosulfonic acid from a sulfite waste liquor and 60 parts by weight of pulverulent silica gel, and the mixture is ground in a hammer mill. Finely distributing the mixture in 20,000 parts by weight of water gives a spray mixture which comprises 0.1% by weight of the active ingredient.

The active ingredients can be used as such, in the form of their formulations or the use forms prepared therefrom, e.g. in the form of directly sprayable solutions, powders, suspensions or dispersions, emulsions, oil dispersions, pastes, dusts, materials for spreading, or granules, by means of spraying, atomizing, dusting, scattering or pouring. The use forms depend entirely on the intended purposes; in any case, this is intended to guarantee the finest possible distribution of the active ingredients according to the invention.

Aqueous use forms can be prepared from emulsion concentrates, pastes or wettable powders (sprayable powders, oil dispersions) by adding water. To prepare emulsions, pastes or oil dispersions, the substances as such or dissolved in an oil or solvent, can be homogenized in water by means of wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active ingredient concentrations in the ready-to-use products can be varied within substantial ranges. In general, they are from 0.0001 to 10%, preferably from 0.01 to 1%.

The active ingredients may also be used successfully in the ultra-low-volume process (ULV), it being possible to apply formulations comprising over 95% by weight of active ingredient, or even the active ingredient without additives.

Compositions to be used according to this invention may also contain other active ingredients, for example other pesticides, insecticides, herbicides, fungicides, other pesticides, or bactericides, fertilizers such as ammonium nitrate, urea, potash, and superphosphate, phytotoxicants and plant growth regulators, safeners and nematicides. These additional ingredients may be used sequentially or in combination with the above-described compositions, if appropriate also added only immediately prior to use (tank mix). For example, the plant(s) may be sprayed with a composition of this invention either before or after being treated with other active ingredients.

These agents can be admixed with the agents used according to the invention in a weight ratio of 1:10 to 10:1. Mixing the compounds I or the compositions comprising them in the use form as pesticides with other pesticides frequently results in a broader pesticidal spectrum of action.

The following list of pesticides together with which the compounds of formula I can be used, is intended to illustrate the possible combinations, but not to impose any limitation:

Organophosphates: Acephate, Azinphos-methyl, Chlorpyrifos, Chlorfenvinphos, Diazinon, Dichlorvos, Dicrotophos, Dimethoate, Disulfoton, Ethion, Fenitrothion, Fenthion, Isoxathion, Malathion, Methamidophos, Methidathion, Methyl-Parathion, Mevinphos, Monocrotophos, Oxydemeton-methyl, Paraoxon, Parathion, Phenthoate, Phosalone, Phosmet, Phosphamidon, Phorate, Phoxim, Pirimiphos-methyl, Profenofos, Prothiofos, Sulprophos, Triazophos, Trichlorfon;

Carbamates: Alanycarb, Benfuracarb, Carbaryl, Carbosulfan, Fenoxycarb, Furathiocarb, lndoxacarb, Methiocarb, Methomyl, Oxamyl, Pirimicarb, Propoxur, Thiodicarb, Triazamate; Pyrethroids: Bifenthrin, Cyfluthrin, Cypermethrin, Deltamethrin, Esfenvalerate, Ethofenprox, Fenpropathrin, Fenvalerate, Cyhalothrin, Lambda-Cyhalothrin, Permethrin, Silafluofen, Tau-Fluvalinate, Tefluthrin, Tralomethrin, Zeta-Cypermethrin;

Arthropod growth regulators: a) chitin synthesis inhibitors: benzoylureas: Chlorfluazuron, Diflubenzuron, Flucycloxuron, Flufenoxuron, Hexaflumuron, Lufenuron, Novaluron, Teflubenzuron, Triflumuron; Buprofezin, Diofenolan, Hexythiazox, Etoxazole, Clofentazine; b) ecdysone antagonists: Halofenozide, Methoxyfenozide, Tebufenozide; c) juvenoids: Pyriproxyfen, Methoprene, Fenoxycarb; d) lipid biosynthesis inhibitors: Spirodiclofen;

Various: Abamectin, Acequinocyl, Amitraz, Azadirachtin, Bifenazate, Cartap, Chlorfenapyr, Chlordimeform, Cyromazine, Diafenthiuron, Dinetofuran, Diofenolan, Emamectin, Endosulfan, Ethiprole, Fenazaquin, Fipronil, Formetanate, Formetanate hydrochloride, Hydramethylnon, Imidacloprid, Indoxacarb, Pyridaben, Pymetrozine, Spinosad, Sulfur, Tebufenpyrad, Thiamethoxam, and Thiocyclam.

The present invention is now illustrated in further details by the following examples.

### I. SYNTHESIS EXAMPLES

### Example 1

### n-Propyl-(2-cyano-3-methyl-phenyl)sulfonamide

### 1.1: 2-Cyano-3-methyl-phenylsulfonylchloride

A solution of 11.6 g (88 mmol) of 2-amino-6-methylbenzonitrile (prepared, e.g. according to WO 94/18980) in 120 ml of glacial acetic acid was initially charged and 32.2 g of concentrated hydrochloric acid were slowly added at room temperature. The reaction mixture was stirred at room temperatures for 10 minutes and then a solution of 6.4 g (92 mmol) of sodium nitrite in 20 ml of water was added dropwise at 5-10° C. The reaction mixture was stirred at 0° C. for one hour to obtain the diazonium salt. In a separate stirred flask, a saturated solution of sulfur dioxide in glacial acetic acid was prepared at 10° C. and a solution of 5.5 g of copper(II) chloride in 11 ml of water was added. The reaction mixture of the diazonium salt which had been prepared beforehand was then added dropwise to the solution of the copper salt. The resulting mixture was stirred at room temperature for additional 45 minutes. Then the reaction mixture was poured into ice-cooled water and the aqueous phase was extracted three times with dichloromethane. The combined organic layers were dried over a drying agent and filtered. The filtrate was concentrated in vacuo to afford 16.4 g (87% of the theory) of the title compound having a melting point of 75-77° C.

### 1.2: n-Propyl-(2-cyano-3-methyl-phenyl)sulfonamide

A solution of 1 g (5 mmol) of 2-cyano-3-methyl-phenylsulfonylchloride in 10 ml of tetrahydrofuran was added to a solution of 630 mg (11 mmol) of n-propylamine in 20 ml of tetrahydrofuran at room temperature. The reaction mixture was stirred at room temperature for 3 hours before water was added. The aqueous phase was acidified with hydrochloric acid (10% strength by weight, aqueous solution) to pH=3 and then extracted three times with dichloromethane. The combined organic extracts were dried over sodium sulfate and filtered. The filtrate was concentrated in vacuo to afford 850 mg (85% of theory) of the title compound having a melting point of 74-77° C.

### Example 2

### Methyl-(2-cyano-3-methoxy-phenyl)sulfonamide

### 2.1: 2-Amino-6-methoxy-benzonitrile

A solution of 70 g (0.5 mol) of 2-amino-6-fluoro-benzonitrile (prepared, e.g. according to U.S. Pat. No. 4,504,660) in 250 ml of N,N-dimethylformamide was initially charged and a solution of 30.6 g (0.55 mol) sodium methoxide in 70 ml of methanol was added dropwise at room temperature while stirring. The mixture was then refluxed for 5 hours under stirring. The completion of the reaction was monitored by TLC. Additional 25 g of sodium methoxide in 35 ml methanol were added and the reaction mixture was refluxed for additional 4 hours while stirring. The reaction mixture was concentrated under reduced pressure, the resulting residue was triturated with water, sucked off and the obtained solids were dissolved in ethyl acetate. The resulting solution was concentrated in vacuo. The obtained residue was triturated with petroleum ether and sucked off to afford 48 g (63% of theory) of a brownish solid having a melting point of 143-146° C.

### 2.2: 2-Cyano-3-methoxy-phenylsulfonylchloride

10 g of concentrated hydrochloric acid were slowly added to a solution of 4.0 (27 mmol) of 2-amino-6-methoxy-benzonitrile in 32 ml of glacial acetic acid at room temperature while stirring. The mixture was stirred at room temperatures for 10 minutes. Then a solution of 1.9 g (27.3 mmol) sodium nitrite in 5 ml of water was added at 5-10° C. and the reaction mixture was stirred at 0° C. for 1 hour to obtain the diazonium salt. In a separate flask, a saturated solution of sulfur dioxide in 68 ml of glacial acetic acid was prepared at room temperature and a solution of 1.7 g of copper(II) chloride in 4 ml of water was added. The reaction mixture of the diazonium salt which had been prepared beforehand was then quickly added to the solution of the copper salt. The resulting mixture was stirred at room temperature for additional 2.5 hours. The reaction mixture was then poured into ice-cooled water. The aqueous layer was extracted three times with dichloromethane. The combined organic extracts were dried over a drying agent and filtered off with suction. The filtrate was concentrated in vacuo to afford 5.3 g (85% of theory) of the title compound having a melting point of 96-99° C.

### 2.3: Methyl-(2-cyano-3-methoxy-phenyl)sulfonamide

A solution of 1.25 g (5.4 mmol) of 2-cyano-3-methoxy-phenylsulfonylchloride in 30 ml of tetrahydrofuran was added to a solution of 960 mg (12 mmol) of an aqueous solution of methylamine (40% by weight) in 20 ml of tetrahydrofuran at room temperature. The reaction mixture was stirred at room temperature for 30 minutes before water was added. The aqueous phase was acidified to pH=3 using hydrochloric acid (10% strength by weight, aqueous solution). The aqueous phase was then extracted three times with dichloromethane. The combined organic extracts were dried over sodium sulfate and filtered. The filtrate was concentrated in vacuo and the resulting residue was triturated with methyl tert-butyl ether to afford 0.28 g (23% of theory) of the title compound having a melting point of 121-128° C.

### Example 3

### Ethyl-(4-chloro-2-cyano-3-methyl-phenyl)sulfonamide

### 3.1: 5-Chloro-6-methyl-2-thiocyano-benzonitrile

30 g (190 mmol) of 2-methyl-3-cyano-4-thiocyanatoaniline (prepared according to EP 0945449) were dissolved in 160 ml of glacial acetic acid and 63 g of concentrated hydrochloric acid were slowly added dropwise under stirring. The mixture was stirred for 10 minutes, and then a solution of 11 g (160 mmol) of sodium nitrite in 23 ml of water was added dropwise at 5-10° C. to obtain the diazonium salt. In a separate flask, a solution of 16 g of copper(I) chloride in 50 ml of concentrated hydrochloric acid was prepared. The reaction mixture of the diazonium salt which had been prepared beforehand was then quickly added dropwise to the solution of the copper salt. The resulting reaction mixture was stirred at room temperature for 24 hours. The reaction mixture was then poured into ice-cooled water and the aqueous phase was extracted three times with dichloromethane. The combined organic layers were dried, filtered and then evaporated. The resulting crude product was purified by column chromatography on silica gel (eluent: toluene/ethyl acetate) to yield 14.3 g (43% of theory) of the title compound having a melting point of 78-80° C.

### 3.2: 4-Chloro-2-cyano-3-methyl-phenylsulfonylchloride

A suspension of 3.0 g (21 mmol) of 5-chloro-6-methyl-2-thiocyanatobenzonitrile in 20 ml of methanol was initially charged, and a solution of 1.9 g (14 mmol) of sodium sulfide in 8 ml of water was added while the temperature was maintained at 20 to 35° C. The resulting yellow solution was stirred at room temperature for 2 days. The mixture was then diluted with water and extracted with methyl tert-butyl ether. The aqueous phase was adjusted to pH 7 by addition of concentrated hydrochloric acid and then extracted with dichloromethane. The aqueous phase was subsequently adjusted to pH 1 by addition of concentrated hydrochloric acid and then extracted with dichloromethane. The organic layer was dried, filtered and then concentrated. The obtained residue was suspended in a mixture of 20 ml of glacial acetic acid, 5 ml of dichloromethane and 18 ml of water and a stream of chlorine gas was then introduced at 25-45° C. over a period of 3 hours. The reaction mixture was diluted with dichloromethane and the organic phase was washed with ice-cooled water. Drying of the organic phase over sodium sulfate was followed by filtration and concentration of the solution to yield 1.3 g (36% of theory) of the title compound having a melting point of 69-72° C.

### 3.3: Ethyl-(4-chloro-2-cyano-3-methyl-phenyl)sulfonamide

An aqueous solution of 770 mg (12 mmol) of ethylamine (70% by weight) in 20 ml of tetrahydrofuran was initially charged, and a solution of 1.3 g (5.2 mmol) of 4-chloro-2-cyano-3-methylphenylsulfonylchloride from 3.2. in 10 ml of tetrahydrofuran was added dropwise at room temperature. The reaction mixture was stirred at room temperature for 2 hours, diluted with water and adjusted to pH 3 by addition of hydrochloric acid (10% strength by weight, aqueous solution). The aqueous phase was extracted three times with dichloromethane. The combined organic layers were dried over sodium sulfate, filtered and then evaporated to dryness in vacuo to obtain 0.5 g (28% of theory) of a brown solid having a melting point of 85-90° C.

The compounds nos. 4 to 191 of the formula I with R⁴═H listed in the following table 1 and the compounds nos. 192 and 193 of the formula I with R⁵═H listed in table 2 were prepared analogously.

TABLE 1

| | |
|---|---|
| | (I) |
| 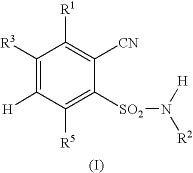 | |

| Example no. | R³ | R⁵ | R¹ | R² | m.p. [° C.] |
|---|---|---|---|---|---|
| 1 | H | H | CH₃ | n-CH₂CH₂CH₃ | 74-77 |
| 2 | H | H | OCH₃ | —CH₃ | 121-128 |
| 3 | Cl | H | CH₃ | —CH₂CH₃ | 85-90 |
| 4 | CN | CH₃ | CH₃ | —CH₃ | 178-180 |
| 5 | Br | H | CH₃ | —CH₂CH₃ | 112-114 |
| 6 | Br | H | CH₃ | cyclopropyl | 140-142 |
| 7 | Br | H | CH₃ | n-C₄H₉ | 112-116 |
| 8 | Br | H | CH₃ | —CH(CH₃)₂ | 102-103 |
| 9 | Br | H | CH₃ | n-CH₂CH₂CH₃ | 119-120 |
| 10 | Br | H | CH₃ | C₆H₅—CH₂— | 139-140 |
| 11 | Br | H | CH₃ | 4-(CH₃)₃C—C₆H₄—CH₂— | 147-151 |
| 12 | H | H | CH₃ | C₆H₅—CH₂— | 117-119 |
| 13 | H | H | CH₃ | 4-(CH₃)₃C—C₆H₄—CH₂— | 97-103 |
| 14 | H | H | CH₃ | 4-Cl—C₆H₄—CH₂— | 150-151 |
| 15 | Br | H | CH₃ | 3-(CH₃O)—C₆H₄—CH₂— | 123-125 |
| 16 | H | H | CH₃ | 3-(CH₃O)—C₆H₄—CH₂— | 117-122 |
| 17 | Br | H | CH₃ | 4-(CH₃O)—C₆H₄—CH₂— | 156-161 |
| 18 | H | H | CH₃ | 4-(CH₃O)—C₆H₄—CH₂— | 127-132 |
| 19 | Br | H | CH₃ | 2-(CH₃O)—C₆H₄—CH₂— | 103-108 |
| 20 | H | H | CH₃ | 2-(CH₃O)—C₆H₄—CH₂— | 127-130 |
| 21 | Br | H | CH₃ | 4-Cl—C₆H₄—CH₂— | 127-131 |
| 22 | Br | H | CH₃ | 3-Cl—C₆H₄—CH₂— | 102-108 |
| 23 | H | H | CH₃ | 3-Cl—C₆H₄—CH₂— | 118-125 |
| 24 | Br | H | CH₃ | 2-Cl—C₆H₄—CH₂— | 118-125 |
| 25 | H | H | CH₃ | 2-Cl—C₆H₄—CH₂— | 128-131 |
| 26 | Br | H | CH₃ | 4-(F₃C)—C₆H₄—CH₂— | 153-155 |
| 27 | H | H | CH₃ | 4-(F₃C)—C₆H₄—CH₂— | 135-137 |
| 28 | Br | H | CH₃ | cyclopropyl-CH₂— | 106-110 |
| 29 | H | H | CH₃ | —CH₃ | 83-89 |
| 30 | H | H | CH₃ | —CH₂CH₃ | 98-103 |
| 31 | H | H | CH₃ | prop-2-ynyl | 104-107 |
| 32 | Br | H | CH₃ | —CH₂—CN | 106-110 |
| 33 | H | H | CH₃ | cyclopropyl-CH₂— | 89-93 |
| 34 | H | H | CH₃ | —CH₂—CN | 130-134 |
| 35 | Br | H | CH₃ | prop-2-ynyl | ¹H-NMR |
| 36 | Br | H | CH₃ | (CH₃)₃C—CH₂— | 112-114 |
| 37 | H | H | CH₃ | (CH₃)₃C—CH₂— | 86-93 |
| 38 | H | H | CH₃ | CH₂═CHCH₂— | ¹H-NMR |
| 39 | H | H | OCH₃ | —CH₂CH₃ | 121-126 |
| 40 | H | H | OCH₃ | C₆H₅—CH₂— | 108-119 |
| 41 | H | H | OCH₃ | —CH(CH₃)₂ | 104-113 |
| 42 | H | H | OCH₃ | prop-2-ynyl | 122-138 |
| 43 | H | H | OCH₃ | —CH₂—CN | ¹H-NMR |
| 44 | H | H | OCH₃ | CH₂═CHCH₂— | ¹H-NMR |
| 45 | H | H | OCH₃ | H | 186-198 |
| 46 | Cl | H | CH₃ | —CH₃ | 112-122 |
| 47 | Cl | H | CH₃ | H | 160-162 |
| 48 | H | H | OCH₂CH₃ | —CH₃ | 91-95 |
| 49 | H | H | OCH₂CH₃ | —CH₂CH₃ | 111-113 |
| 50 | H | H | OCH₂CH₃ | H | 183-186 |
| 51 | Cl | H | CH₃ | C₆H₅—CH₂— | 132-135 |
| 52 | Cl | H | CH₃ | —CH(CH₃)₂ | 86-94 |
| 53 | Cl | H | CH₃ | prop-2-ynyl | ¹H-NMR |
| 54 | Cl | H | CH₃ | H₂C═CHCH₂— | 95-96 |
| 55 | Cl | H | CH₃ | FH₂CCH₂— | 115-121 |
| 56 | H | H | OCH₂CH₃ | C₆H₅—CH₂— | oil |
| 57 | H | H | OCH₂CH₃ | prop-2-ynyl | 105-112 |
| 58 | H | H | OCH₂CH₃ | —CH₂—CN | 129-134 |
| 59 | H | H | OCH₂CH₃ | CH₂═CHCH₂— | oil |
| 60 | H | H | OCH₂CH₃ | —CH₂—CH₂—CH₃ | 113-115 |
| 61 | H | H | OCH₂CH₃ | cyclopropyl-CH₂ | 128-130 |
| 62 | Cl | H | CH₃ | —CH₂—CN | 134-138 |
| 63 | H | H | OCH₂CH₃ | —CH₂—CF₃ | oil |
| 64 | H | H | OCH₂CH═CH₂ | —CH₂—CH₃ | oil |
| 65 | H | H | OCH(CH₃)₂ | —CH₂—CH₃ | oil |
| 66 | H | H | OCHF₂ | —CH₂—CH₃ | 98-100 |
| 67 | H | H | OCH(CH₃)₂ | H | 132-136 |
| 68 | H | H | OCH(CH₃)₂ | prop-2-ynyl | oil |
| 69 | H | H | OCH(CH₃)₂ | —CH₂CN | oil |
| 70 | H | H | OCH(CH₃)₂ | cyclopropyl | oil |
| 71 | H | H | OCH(CH₃)₂ | —CH(CH₃)₂ | oil |
| 72 | H | H | OCH(CH₃)₂ | C₆H₅—CH₂— | oil |
| 73 | H | H | OCH(CH₃)₂ | —CH₂—CH₃ | oil |
| 74 | Br | H | CH₃ | H | 149-151 |
| 75 | H | H | CH₃ | H | 171-174 |
| 76 | H | H | OCH(CH₃)₂ | O—CH₂—CH₃ | oil |
| 77 | H | H | OCH(CH₃)₂ | —CH₂—CH₂—CH₃ | oil |
| 78 | H | H | OCHF₂ | H | 135-137 |
| 79 | H | H | OCHF₂ | —CH₂—C≡CH | 65-70 |
| 80 | H | H | OCH₂CHClCH₂Cl | H | 123-129 |
| 81 | H | H | OCH(CH₃)₂ | —CH₃ | 82-91 |
| 82 | H | H | OCH₃ | —CH₂-c-C₃H₅ | 92-95 |
| 83 | H | H | OCH₃ | -c-C₃H₅ | 142-148 |
| 84 | H | H | OCH₃ | —O—CH₂—CH₃ | 138-143 |
| 85 | H | H | OCH₃ | —CH₂—CH₂—CN | 123-130 |
| 86 | H | H | OCH₃ | —CH₂—CH₂—S—CH₃ | oil |
| 87 | H | H | OCH₃ | —CH₂—CH₂—S(O)₂—CH₃ | 157-160 |
| 88 | H | H | OCH₃ | —CH₂—CH₂F | 134-140 |
| 89 | H | H | OCHF₂ | H | 122-128 |
| 90 | H | H | OCH₃ | —CH₂—CF₃ | 136-141 |
| 91 | H | H | OCH₃ | —CH₂—CHF₂ | 116-118 |
| 92 | H | H | OCH₃ | —O—CH₃ | 136-139 |
| 93 | Br | H | OCH₃ | —CH₂—C≡CH | 110-115 |
| 94 | H | H | OCH₃ | —CH₂—CH₂—N(CH₃)₂ | 94-97 |
| 95 | Br | H | OCH₃ | —CH₂—C₆H₅ | 134-136 |
| 96 | H | H | OCHF₂ | —CH₂—CF₃ | 120-138 |
| 97 | H | H | OCHF₂ | —CH₂—C₆H₅ | 115-117 |
| 98 | H | H | OCHF₂ | -c-C₃H₅ | 87-91 |
| 99 | H | H | OCHF₂ | —CH₂—CH₂—S—CH₃ | ¹H-NMR |
| 100 | Br | H | OCHF₂ | —CH₃ | 168-173 |
| 101 | H | H | OCHF₂ | —CH₂—CH═CH₂ | 75-78 |
| 102 | H | H | OCHF₂ | —CH₂-c-C₃H₅ | ¹H-NMR |
| 103 | H | H | OCHF₂ | —CH₂—CH₂—CH₃ | 54-58 |
| 104 | H | H | OCHF₂ | —CH₂—CH₂—O—CH₃ | ¹H-NMR |
| 105 | H | H | OCHF₂ | —CH₂—CH₂—CN | 83-88 |
| 106 | H | H | OCHF₂ | —CH—(CH₃)₂ | 72-74 |
| 107 | H | H | OCHF₂ | —CH₂—CHF₂ | 92-96 |
| 108 | H | H | OCHF₂ | —O—CH₃ | oil |
| 109 | H | H | CF₃ | —CH₂—CH₃ | 81-86 |
| 110 | H | H | CF₃ | —CH₂—C≡CH | 106-111 |
| 111 | H | H | CF₃ | —CH₂—C₆H₅ | 106-108 |
| 112 | H | H | CF₃ | —CH₃ | 104-113 |
| 113 | H | H | CF₃ | —CH₂—CH═CH₂ | 71-73 |
| 114 | H | H | CF₃ | —CH—(CH₃)₂ | 65-67 |
| 115 | H | H | CF₃ | —CH₂—CH₂—CH₃ | 62-66 |
| 116 | H | H | CF₃ | —CH₂-c-C₃H₅ | oil |
| 117 | H | H | CF₃ | —CH₂—CF₃ | oil |
| 118 | H | H | CF₃ | —CH₂—CH₂—S—CH₃ | oil |
| 119 | H | H | CF₃ | -c-C₃H₅ | 94-96 |
| 120 | H | H | CF₃ | —O—CH₂—CH₃ | 118-120 |
| 121 | H | H | CF₃ | —CH₂—CH₂—SO₂—CH₃ | 169-171 |
| 122 | H | H | CH₃ | —O—CH₂—CH₃ | 118-121 |
| 123 | H | H | CH₃ | —O—CH₃ | 136-140 |
| 124 | H | H | CH₃ | -cyclobutyl | HPLC/MS |
| 125 | H | H | CH₃ | -cyclopentyl | HPLC/MS |
| 126 | H | H | CH₃ | -cyclohexyl | HPLC/MS |
| 127 | H | H | CH₃ | -cyclopropyl | HPLC/MS |
| 128 | H | H | CH₃ | —C(CH₃)₂—CH₂—CH₃ | HPLC/MS |
| 129 | H | H | CH₃ | —CH₂—CH₂—CH₂—N(C₂H₅)₂ | HPLC/MS |
| 130 | H | H | CH₃ | —CH(CH₃)—CH(CH₃)₂ | HPLC/MS |
| 131 | H | H | CH₃ | —CH(CH₃)—C(CH₃)₃ | HPLC/MS |
| 132 | H | H | CH₃ | —C(CH₃)₃ | HPLC/MS |
| 133 | H | H | CH₃ | —C(CH₃)(C₂H₅)—CH₂—CH₃ | HPLC/MS |
| 134 | H | H | CH₃ | —C(CH₃)₂—CH₂—CH₂—CH₃ | HPLC/MS |
| 135 | H | H | CH₃ | —CH₂—CH₂—N[CH(CH₃)₂]₂ | HPLC/MS |
| 136 | H | H | CH₃ | —CH₂—CH₂—O—C₂H₅ | HPLC/MS |
| 137 | H | H | CH₃ | —CH(C₂H₅)₂ | HPLC/MS |
| 138 | H | H | CH₃ | —CH(CH₃)—CH₂—CH(CH₃)₂ | HPLC/MS |
| 139 | H | H | CH₃ | —CH(C₂H₅)—CH₂—O—CH₃ | HPLC/MS |
| 140 | H | H | CH₃ | —C(CH₃)₂—C≡CH | HPLC/MS |
| 141 | H | H | CH₃ | —CH(CH₃)—CH₂—O—C₂H₅ | HPLC/MS |
| 142 | H | H | CH₃ | —CH(CH₃)—CH₂—O—CH₃ | HPLC/MS |
| 143 | H | H | CH₃ | —CH₂—CH(CH₃)—C₂H₅ | HPLC/MS |
| 144 | H | H | CH₃ | —CH(CH₃)—CH₂—S—CH₃ | HPLC/MS |
| 145 | H | H | CH₃ | —CH₂—CH(OCH₃)₂ | ¹H-NMR |
| 146 | H | H | CH₃ | —CH₂—CH₂—C(CH₃)₃ | HPLC/MS |
| 147 | H | H | CH₃ | —CH₂—CH(OC₂H₅)₂ | HPLC/MS |
| 148 | H | H | CH₃ | —CH₂—CH₂—S—CH₃ | HPLC/MS |
| 149 | H | H | CH₃ | —CH₂—CH(CH₃)₂ | HPLC/MS |
| 150 | H | H | CH₃ | —CH₂—CH₂—CH(CH₃)₂ | HPLC/MS |
| 151 | H | H | CH₃ | —CH₂—CH₂—CH₂—O—CH₃ | HPLC/MS |
| 152 | H | H | CH₃ | —CH₂—CH(CH₃)—O—CH₃ | HPLC/MS |
| 153 | H | H | CH₃ | —CH₂—CH(CH₃)—CH₂—C₂H₅ | HPLC/MS |
| 154 | H | H | CH₃ | —CH₂—CH₂—CH₂—S—CH₃ | HPLC/MS |
| 155 | H | H | CH₃ | —C(CH₃)₂—CH₂—S—C₂H₅ | HPLC/MS |
| 156 | H | H | CH₃ | —C(CH₃)₂—CH₂—S—CH₃ | HPLC/MS |
| 157 | H | H | CH₃ | —CH(CH₃)—CH₂—N(CH₃)₂ | HPLC/MS |
| 158 | H | H | CH₃ | —C(CH₃)(n-C₃H₇)₂—C≡CH | HPLC/MS |
| 159 | H | H | CH₃ | —C(CH₃)₂—CH═CH₂ | HPLC/MS |
| 160 | H | H | CH₃ | —CH(CH₃)—C(O)—O—CH₃ | HPLC/MS |
| 161 | H | H | CH₃ | —CH(CH₃)-c-C₃H₅ | HPLC/MS |
| 162 | H | H | CH₃ | —CH₂—CF₃ | HPLC/MS |
| 163 | H | H | CH₃ | —CH₂—O—CH₃ | HPLC/MS |
| 164 | H | H | CH₃ | —CH(CH₃)—C₂H₅ | HPLC/MS |
| 165 | H | H | CH₃ | CH(CH₃)₂ | HPLC/MS |
| 166 | H | H | CH₃ | —C(CH₃)₂—CH₂—CN | HPLC/MS |
| 167 | H | H | CH₃ | —CH₂—CH₂—CH₂—N(CH₃)₂ | HPLC/MS |
| 168 | H | H | CH₃ | —CH₂—CH₂—CH₂—CH₂—CH₃ | HPLC/MS |
| 169 | H | H | CH₃ | —CH₂—CH₂—F | HPLC/MS |
| 170 | H | H | CH₃ | —CH₂—CH₂—CH₂—O—C₂H₅ | HPLC/MS |
| 171 | H | H | CH₃ | —CH₂—CH₂—O—CH(CH₃)₂ | HPLC/MS |
| 172 | H | H | CH₃ | —CH(CH₃)—CH₂—Cl | HPLC/MS |
| 173 | H | H | CH₃ | —CH₂—CH₂—CH₂—Cl | HPLC/MS |
| 174 | H | H | CH₃ | —CH₂—C≡C—CH₂—Cl | HPLC/MS |
| 175 | H | H | CH₃ | —CH₂—C(O)—O—CH₃ | HPLC/MS |
| 176 | H | H | CH₃ | —CH₂—CH₂—CH₂—Br | HPLC/MS |
| 177 | H | H | CH₃ | —CH₂—CH₂—CH₂—CH₃ | HPLC/MS |
| 178 | H | H | CH₃ | —CH₂—CH₂—S—C₂H₅ | HPLC/MS |
| 179 | CN | H | CH₃ | —CH₂—CH₃ | 114-119 |
| 180 | CN | H | CH₃ | —CH₃ | 172-175 |
| 181 | CN | H | CH₃ | —CH₂—C≡CH | 95-105 |
| 182 | CN | H | CH₃ | H | oil |
| 183 | CN | H | CH₃ | —CH₂—CH═CH₂ | 83-95 |
| 184 | CN | H | CH₃ | —CH₂—CH₂—CH₃ | 95-99 |
| 185 | CN | H | CH₃ | —CH₂—CH₂—F | oil |
| 186 | CN | H | CH₃ | -cyclopropyl | oil |
| 187 | CN | H | CH₃ | —O—CH₃ | 139-142 |
| 188 | OCH₃ | H | CH₃ | —CH₂—CH₃ | 171-174 |
| 189 | OCH₃ | H | CH₃ | —CH₂—C≡CH | 151-155 |
| 190 | OCH₃ | H | CH₃ | —H | 171-180 |
| 191 | OCH₃ | H | CH₃ | —CH₃ | 171-175 |

m.p. melting point;
c-C₃H₅: cyclopropyl;
n-C₃H₇: n-propyl

Some compounds were characterized by ¹H-NMR. The signals are characterized by chemical shift (ppm) vs. tetramethylsilane, by their multiplicity and by their integral (relative number of hydrogen atoms given). The following abbreviations are used to characterize the multiplicity of the signals: m=multiplett, t=triplett, d=doublett and s=singulett.

### Example 35

### 2.06 (t, 1H), 2.72 (s, 3H), 3.92 (m, 2H), 5,56 (t, 1H), 7.85 (d, 1H), 7.92 (d, 1H), CDCl₃

### Example 38

### 2.66 (s, 3H), 3.67 (m, 2H), 5.12 (d, 1H), 5.21 (d, 1H), 5.30 (t, 1H), 5.74 (m, 1H), 7.56 (d, 1H), 7.62 (t, 1H), 7.95 (d, 1H), CDCl₃

### Example 43

### 4.04 (s, 3H), 4.13 (d, 2H), 6.15 (t, 1H), 7.30 (m, 1H), 7.72 (m, 2H), CDCl₃

### Example 44

### 3.67 (m, 2H), 4.04 (s, 3H), 5.11 (d, 1H), 5.23 (m, 2H), 5.76 (m, 1H), 7.23 (dd, 1H), 7.68 (m, 2H), CDCl₃

### Example 53

### 2.07 (m, 1H), 2.72 (s, 3H), 3.95 (m, 2H), 5.52 (t, 1H), 7.72 (d, 1H), 7.95 (d, 1H), CDCl₃

### Example 99

### 2.05 (s, 3H), 2.66 (t, 2H), 3.28 (q, 2H), 5.62 (t, 1H), 6.73 (t, 1H), 7.59 (d, 1H), 7.77 (t, 1H), 7.99 (d, 1H), CDCl₃

### Example 102

### 0.13 (m, 2H), 0.31 (m, 2H), 0.90 (m, 1H), 2.95 (t, 2H), 5.32 (t, 1H), 6.72 (t, 1H), 7.57 (d, 1H), 7.77 (t, 1H), 8.00 (d, 1H), CDCl₃

### Example 104

### 3.27 (s, 3H), 3.33 (m, 2H), 3.43 (m, 2H), 5.56 (t, 1H), 6.75 (t, 1H), 7.58 (d, 1H), 7.77 (t, 1H), 8.00 (d, 1H), CDCl₃

### Example 145

### 2.65 (s, 3H), 3.15 (pt, 2H), 3.3 (s, 6H), 4.35 (t, 1H), 5.65 (t, 1H) 7.55 (d, 1H), 7.6 (t, 1H), 7.9 (d, 1H), CDCl₃

Some compounds were characterized by coupled High Performance Liquid Chromatography/mass spectrometry (HPLC/MS).

HPLC column: RP-18 column (Chromolith Speed ROD from Merck KgaA, Germany). Elution: acetonitrile+0.1% trifluoroacetic acid (TFA)/water in a ratio from 5:95 to 95:5 in 5 minutes at 40° C.

MS: Quadrupol electrospray ionisation, 80 V (positiv modus)

### Example 124

### 2.813 min, m/z=273 [M+Na]⁺

### Example 125

### 3.043 min, m/z=287 [M+Na]⁺

### Example 126

### 3.260 min, m/z=279 [M+H]⁺

### Example 127

### 2.486 min, m/z=237 [M+H]⁺

### Example 128

### 3.198 min, m/z=267 [M+H]⁺

### Example 129

### 1.955 min, m/z=310 [M+H]⁺

### Example 130

### 3.244 min, m/z=267 [M+H]⁺

### Example 131

### 3.438 min, m/z=281 [M+H]⁺

### Example 132

### 3.004 min, m/z=253 [M+H]⁺

### Example 133

### 3.483 min, m/z=303 [M+H]⁺

### Example 134

### 3.533 min, m/z=281 [M+H]⁺

### Example 135

### 2.091 min, m/z=324 [M+H]⁺

### Example 136

### 2.534 min, m/z=269 [M+H]⁺

### Example 137

### 3.154 min, m/z=267 [M+H]⁺

### Example 138

### 3.413 min, m/z=303 [M+H]⁺

### Example 139

### 2.761 min, m/z=283 [M+H]⁺

### Example 140

### 2.740 min, m/z=263 [M+H]⁺

### Example 141

### 2.802 min, m/z=283 [M+H]⁺

### Example 142

### 2.596 min, m/z=269 [M+H]⁺

### Example 143

### 3.225 min, m/z=267 [M+H]⁺

### Example 144

### 3.836 min, m/z=285 [M+H]⁺

### Example 146

### 3.430 min, m/z=281 [M+H]⁺

### Example 147

### 2.934 min, m/z=335 [M+Na]⁺

### Example 148

### 2.677 min, m/z=271 [M+H]⁺

### Example 149

### 2.989 min, m/z=253 [M+H]⁺

### Example 150

### 3.254 min, m/z=267 [M+H]⁺

### Example 151

### 2.443 min, m/z=269 [M+H]⁺

### Example 152

### 2.481 min, m/z=269 [M+H]⁺

### Example 153

### 3.501 min, m/z=281 [M+H]⁺

### Example 154

### 2.750 min, m/z=285 [M+H]⁺

### Example 155

### 3.362 min, m/z=335 [M+Na]⁺

### Example 156

### 3.116 min, m/z=321 [M+Na]⁺

### Example 157

### 1.740 min, m/z=282 [M+H]⁺

### Example 158

### 3.249 min, m/z=291 [M+H]⁺

### Example 159

### 2.985 min, m/z=265 [M+H]⁺

### Example 160

### 2.364 min, m/z=283 [M+H]⁺

### Example 161

### 2.919 min, m/z=265 [M+H]⁺

### Example 162

### 2.644 min, m/z=301 [M+Na]⁺

### Example 163

### 2.177 min, m/z=255 [M+H]⁺

### Example 164

### 2.917 min, m/z=253 [M+H]⁺

### Example 165

### 2.570 min, m/z=239 [M+H]⁺

### Example 166

### 2.500 min, m/z=278 [M+H]⁺

### Example 167

### 3.314 min, m/z=282 [M+H]⁺

### Example 168

### 3.297 min, m/z=267 [M+H]⁺

### Example 169

### 2.259 min, m/z=243 [M+H]⁺

### Example 170

### 2.709 min, m/z=283 [M+H]⁺

### Example 171

### 2.814 min, m/z=283 [M+H]⁺

### Example 172

### 2.733 min, m/z=273 [M+H]⁺

### Example 173

### 2.729 min, m/z=273 [M+H]⁺

### Example 174

### 2.743 min, m/z=283 [M+H]⁺

### Example 175

### 2.187 min, m/z=269 [M+H]⁺

### Example 176

### 2.935 min, m/z=317 [M+H]⁺

### Example 177

### 3.090 min, m/z=253 [M+H]⁺

### Example 178

### 2.956 min, m/z=285 [M+H]⁺

TABLE 2

| | |
|---|---|
| | (I) |
| 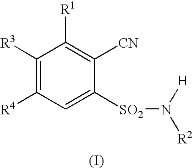 | |

| Example no. | R³ | R⁴ | R¹ | R² | m.p. [° C.] |
|---|---|---|---|---|---|
| 191 | H | Cl | CH₃ | CH₂CH₃ | 119-123 |
| 192 | H | Br | CH₃ | CH₂CH₃ | 141-144 |

### II. EXAMPLES OF ACTION AGAINST PESTS

The action of the compounds of the formula I against pests was demonstrated by the following experiments:

Green Peach Aphid (Myzus persicae)

The active compounds were formulated in 50:50 acetone:water and 100 ppm Kinetic® surfactant.

Pepper plants in the 2^{nd} leaf-pair stage (variety ‘California Wonder’) were infested with approximately 40 laboratory-reared aphids by placing infested leaf sections on top of the test plants. The leaf sections were removed after 24 hr. The leaves of the intact plants were dipped into gradient solutions of the test compound and allowed to dry. Test plants were maintained under fluorescent light (24 hour photoperiod) at about 25° C. and 20-40% relative humidity. Aphid mortality on the treated plants, relative to mortality on check plants, was determined after 5 days.

In this test, compounds nos. 1, 2, 3, 5, 12, 23, 29, 30, 31, 33, 37, 38, 39, 40, 41, 42, 43, 45, 46, 47, 48, 49, 50, 52, 53, 54, and 55 at 300 ppm showed over 85% mortality in comparison with untreated controls.

Cotton Aphid (Aphis gossypii)

The active compounds were formulated in 50:50 acetone:water and 100 ppm Kinetic® surfactant.

Cotton plants in the cotyledon stage (variety ‘Delta Pine’, one plant per pot) were infested by placing a heavily infested leaf from the main colony on top of each cotyledons. The aphids were allowed to transfer to the host plant overnight, and the leaf used to transfer the aphids were removed. The cotyledons were dipped in the test solution and allowed to dry. After 5 days, mortality counts were made.

In this test, compounds nos. 2, 3, 5, 6, 8, 10,12,13,14, 15, 16, 18, 19, 20, 21, 22, 23, 24, 25, 27, 28,29,30,31,32,35,36,37,38,39,40,41,42,43,44,45,46, 47, 48, 49, 50, 51, 52, 53, 54, and 55 at 300 ppm showed over 85% mortality in comparison with untreated controls.

Bean Aphid (Aphis fabae)

The active compounds were formulated in 50:50 acetone:water and 100 ppm Kinetic® surfactant.

Nastirtum plants grown in Metro mix in the 1^{st} leaf-pair stage (variety ‘Mixed Jewel’) were infested with approximately 2-30 laboratory-reared aphids by placing infested cut plants on top of the test plants. The cut plants were removed after 24 hr. Each plant was dipped into the test solution to provide complete coverage of the foliage, stem, protruding seed surface and surrounding cube surface and allowed to dry in the fume hood. The treated plants were kept at about 25° C. with continuous fluorescent light. Aphid-mortality is determined after 3 days.

In this test, compounds nos. 30, 38, 5, 6, 7, 8, 23, 29, 32, 33, 34, 35, 40, 41, 42, and 45 at 300 ppm showed over 85% mortality in comparison with untreated controls.

Silverleaf whitefly (Bemisia argentifolil)

The active compounds were formulated in 50:50 acetone:water and 100 ppm Kinetic® surfactant.

Selected cotton plants were grown to the cotyledon state (one plant per pot). The cotyledons were dipped into the test solution to provide complete coverage of the foliage and placed in a well-vented area to dry. Each pot with treated seedling was placed in a plastic cup and 10 to 12 whitefly adults (approximately 3-5 day old) were introduced. The insects were collected using an aspirator and an 0.6 cm, non-toxic Tygon® tubing (R-3603) connected to a barrier pipette tip. The tip, containing the collected insects, was then gently inserted into the soil containing the treated plant, allowing insects to crawl out of the tip to reach the foliage for feeding. The cups were covered with a reusable screened lid (150 micron mesh polyester screen PeCap from Tetko Inc). Test plants were maintained in the holding room at about 25° C. and 20-40% humidity for 3 days avoiding direct exposure to the fluorescent light (24 photoperiod) to prevent trapping of heat inside the cup. Mortality was assessed 3 days after treatment of the plants.

In this test, compounds no. 5 and 42 at 300 ppm showed over 70% mortality compared to untreated controls.

2-spotted Spider Mite (Tetranychus urticae, OP-Resistant Strain)

Sieva lima bean plants (variety ‘Henderson’) with primary leaves expanded to 7-12 cm were infested by placing on each a small piece from an infested leaf (with about 100 mites) taken from the main colony. This was done at about 2 hours before treatment to allow the mites to move over to the test plant to lay eggs. The piece of leaf used to transfer the mites was removed. The newly-infested plants were dipped in the test solution and allowed to dry. The test plants were kept under fluorescent light (24 hour photoperiod) at about 25° C. and 20-40% relative humidity. After 5 days, one leaf was removed and mortality counts were made.

In this test, compounds nos. 8 and 30 at 300 ppm showed over 75% mortality compared to untreated controls.

Florida Carpenter Ant (Camponotus floridanus)

The tests were conducted in petri dishes. Ants were given a water source and then were starved of a food source for 24 hours. Baits were prepared with 20% honey/water solution. A solution of the active ingredient in acetone was added to reach a concentration of the active ingredient of 1% by weight (w/w). 0.2 ml of the active ingredient containing honey/water solution, placed in a cap, was added to each dish. The dishes were covered and maintained at a water temperature of 22° C. The ants were observed for mortality daily. Mortality was determined after 10 days.

In these tests, compounds nos. 66, 78 and 79 showed over 85% mortality compared to untreated controls.

Argentine Ants (Linepithema humile)

a) The tests were conducted in petri dishes. Ants were given a water source and then were starved of a food source for 24 hours. Baits were prepared with 20% honey/water solution. A solution of the active ingredient in acetone was added to reach a concentration of the active ingredient of 1% by weight (w/w). 0.2 ml of the active ingredient containing honey/water solution, placed in a cap, was added to each dish. The dishes were covered and maintained at a water temperature of 22° C. The ants were observed for mortality daily. Mortality was determined after 10 days.
   In these tests, compounds nos. 66, 78 and 79 showed 100% mortality compared to untreated controls.

b) The tests were conducted as in example a). The following compounds I and II according to EP 33984 were used as comparative examples. The ants were observed for mortality after 6 days. The results are shown in Table 3.

TABLE 3
Bioactivity against Argentine ants, Linepithema humile

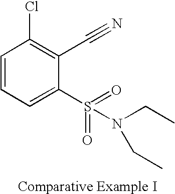

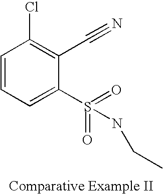

| | % ai¹⁾ | Mean cumulative % mortality 6 days |
|---|---|---|
| Treatment | (w/w) | after treatment²⁾ |
| Compound No. 66 | 1.0 | 100.0 |
| Comparative Example I | 1.0 | 35.6 |
| Comparative Example II | 1.0 | 35.6 |
| Control²⁾ | na | 17.8 |

¹⁾% active ingredient
²⁾each mean is based on 45 ants (3 replications/treatment)

1-18. (canceled)

19. A 2-cyanobenzenesulfonamide compound of the general formula I 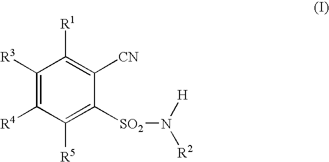
where
R¹ is C₁-C₄-alkyl, C₁-C₄-haloalkyl, C₁-C₄-alkoxy or C₁-C₄-haloalkoxy;
R² is hydrogen, C₁-C₆-alkyl, C₂-C₆-alkenyl, C₂-C₆-alkinyl, C₃-C₈-cycloalkyl or C₁-C₄-alkoxy, wherein the five last-mentioned radicals may be unsubstituted, partially or fully halogenated and/or may carry one, two, or three radicals selected from the group consisting of C₁-C₄-alkoxy, C₁-C₄-alkylthio, C₁-C₄-alkylsulfinyl, C₁-C₄-alkylsulfonyl, C₁-C₄-haloalkoxy, C₁-C₄-haloalkylthio, C₁-C₄-alkoxycarbonyl, cyano, amino, (C₁-C₄-alkyl)amino, di-(C₁-C₄-alkyl)amino, C₃-C₈-cycloalkyl and phenyl, it being possible for phenyl to be unsubstituted, partially or fully halogenated and/or to carry one, two or three substituents selected from the group consisting of C₁-C₄-alkyl, C₁-C₄-haloalkyl, C₁-C₄-alkoxy, C₁-C₄-haloalkoxy; and
R³, R⁴ and R⁵ are independently of one another selected from the group consisting of hydrogen, halogen, cyano, nitro, C₁-C₆-alkyl, C₃-C₈-cycloalkyl, C₁-C₄-haloalkyl, C₁-C₄-alkoxy, C₁-C₄-alkylthio, C₁-C₄-alkylsulfinyl, C₁-C₄-alkylsulfonyl, C₁-C₄-haloalkoxy, C₁-C₄-haloalkylthio, C₂-C₆-alkenyl, C₂-C₆-alkinyl, C₁-C₄-alkoxycarbonyl, amino, (C₁-C₄-alkyl)amino, di-(C₁-C₄-alkyl)amino, aminocarbonyl, (C₁-C₄-alkyl)aminocarbonyl and di-(C₁-C₄-alkyl)aminocarbonyl;
and/or the agriculturally useful salts thereof, except for 5-bromo-2-cyano-3,6-diispropylbenzene sulfonamide.

20. A compound as claimed in claim 19 wherein in formula I R¹ is C₁-C₂-alkyl or C₁-C₂-alkoxy.

21. A compound as claimed in claim 20 wherein in formula I R¹ is methyl.

22. A compound as claimed in claim 20 wherein in formula I R¹ is methoxy.

23. A compound as claimed in claim 19 wherein in formula I R¹ is C₁-C₄-haloalkoxy.

24. A compound as claimed in claim 23 wherein in formula I R¹ is C₁-haloalkoxy.

25. A compound as claimed in claim 24 wherein in formula I R₁ is difluroromethoxy.

26. A compound as claimed in claim 19 wherein in formula I R² is selected from the group consisting of hydrogen, a hydrocarbon radical having from 1 to 4 carbon atoms, C₁-C₄-alkoxy-C₁-C₄-alkyl, C₁-C₄-alkylthio-C₁-C₄-alkyl and C₂-C₄-alkinyl.

27. A compound as claimed in claim 23 wherein R² is hydrogen, methyl, ethyl, 1-methylethyl, or prop-2-yn-1-yl.

28. A compound as claimed in claim 19 where in formula I at least one of the radicals R³, R⁴ and R⁵ is different from hydrogen.

29. A compound as claimed in claim 28 where R³ is halogen.

30. A compound as claimed in claim 29, wherein R⁴ and R⁵ are hydrogen.

31. A compound as claimed in claim 19 where in formula I the radicals R³, R⁴ or R⁵ represent hydrogen.

32. An agricultural composition comprising such an amount of at least one compound of the general formula I 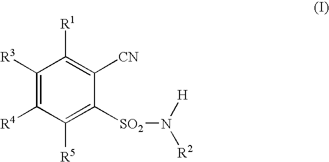
where
R¹ is C₁-C₄-alkyl, C₁-C₄-haloalkyl, C₁-C₄-alkoxy or C₁-C₄-haloalkoxy;
R² is hydrogen, C₁-C₆-alkyl, C₂-C₆-alkenyl, C₂-C₆-alkinyl, C₃-C₈-cycloalkyl or C₁-C₄-alkoxy, wherein the five last-mentioned radicals may be unsubstituted, partially or fully halogenated and/or may carry one, two, or three radicals selected from the group consisting of C₁-C₄-alkoxy, C₁-C₄-alkylthio, C₁-C₄-alkylsulfinyl, C₁-C₄-alkylsulfonyl, C₁-C₄-haloalkoxy, C₁-C₄-haloalkylthio, C₁-C₄-alkoxycarbonyl, cyano, amino, (C₁-C₄-alkyl)amino, di-(C₁-C₄-alkyl)amino, C₃-C₈-cycloalkyl and phenyl, it being possible for phenyl to be unsubstituted, partially or fully halogenated and/or to carry one, two or three substituents selected from the group consisting of C₁-C₄-alkyl, C₁-C₄-haloalkyl, C₁-C₄-alkoxy, C₁-C₄-haloalkoxy; and
R³, R⁴ and R⁵ are independently of one another selected from the group consisting of hydrogen, halogen, cyano, nitro, C₁-C₆-alkyl, C₃-C₈-cycloalkyl, C₁-C₄-haloalkyl, C₁-C₄-alkoxy, C₁-C₄-alkylthio, C₁-C₄-alkylsulfinyl, C₁-C₄-alkylsulfonyl, C₁-C₄-haloalkoxy, C₁-C₄-haloalkylthio, C₂-C₆-alkenyl, C₂-C₆-alkinyl, C₁-C₄-alkoxycarbonyl, amino, (C₁-C₄-alkyl)amino, di-(C₁-C₄-alkyl)amino, aminocarbonyl, (C₁-C₄-alkyl)aminocarbonyl and di-(C₁-C₄-alkyl)aminocarbonyl;
and/or at least one agriculturally useful salt of I and at least one inert liquid and/or solid agronomically acceptable carrier that it has a pesticidal action and, if desired, at least one surfactant.

33. A method of combating animal pests which comprises contacting the animal pests, their habit, breeding ground, food supply, plant, seed, soil, area, material or environment in which the animal pests are growing or may grow, or the materials, plants, seeds, soils, surfaces or spaces to be protected from animal attack or infestation with a pesticidally effective amount of at least one 2-cyano-benzenesulfonamide compound of the general formula I 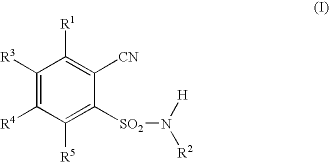
where
R¹ is C₁-C₄-alkyl, C₁-C₄-haloalkyl, C₁-C₄-alkoxy or C₁-C₄-haloalkoxy;
R² is hydrogen, C₁-C₆-alkyl, C₂-C₆-alkenyl, C₂-C₆-alkinyl, C₃-C₈-cycloalkyl or C₁-C₄-alkoxy, wherein the five last-mentioned radicals may be unsubstituted, partially or fully halogenated and/or may carry one, two, or three radicals selected from the group consisting of C₁-C₄-alkoxy, C₁-C₄-alkylthio, C₁-C₄-alkylsulfinyl, C₁-C₄-alkylsulfonyl, C₁-C₄-haloalkoxy, C₁-C₄-haloalkylthio, C₁-C₄-alkoxycarbonyl, cyano, amino, (C₁-C₄-alkyl)amino, di-(C₁-C₄-alkyl)amino, C₃-C₈-cycloalkyl and phenyl, it being possible for phenyl to be unsubstituted, partially or fully halogenated and/or to carry one, two or three substituents selected from the group consisting of C₁-C₄-alkyl, C₁-C₄-haloalkyl, C₁-C₄-alkoxy, C₁-C₄-haloalkoxy; and
R³, R⁴ and R⁵ are independently of one another selected from the group consisting of hydrogen, halogen, cyano, nitro, C₁-C₆-alkyl, C₃-C₈-cycloalkyl, C₁-C₄-haloalkyl, C₁-C₄-alkoxy, C₁-C₄-alkylthio, C₁-C₄-alkylsulfinyl, C₁-C₄-alkylsulfonyl, C₁-C₄-haloalkoxy, C₁-C₄-haloalkylthio, C₂-C₆-alkenyl, C₂-C₆-alkinyl, C₁-C₄-alkoxycarbonyl, amino, (C₁-C₄-alkyl)amino, di-(C₁-C₄-alkyl)amino, aminocarbonyl, (C₁-C₄-alkyl)aminocarbonyl and di-(C₁-C₄-alkyl)aminocarbonyl;
and/or at least one agriculturally acceptable salt thereof.

34. A method as defined in claim 33 where the animal pest is from the order Homoptera.

35. A method as defined in claim 33 where the animal pest is from the order Hymenoptera.

36. A method as defined in claim 33 where the animal pest is from the order Thysanoptera.

37. A method for protecting crops from attack or infestation by animal pests which comprises contacting a crop with a pesticidally effective amount of at least one 2-cyano-benzenesulfonamide compound of the general formula I 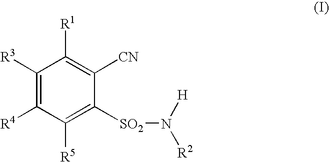
where
R¹ is C₁-C₄-alkyl, C₁-C₄-haloalkyl, C₁-C₄-alkoxy or C₁-C₄-haloalkoxy;
R² is hydrogen, C₁-C₆-alkyl, C₂-C₆-alkenyl, C₂-C₆-alkinyl, C₃-C₈-cycloalkyl or C₁-C₄-alkoxy, wherein the five last-mentioned radicals may be unsubstituted, partially or fully halogenated and/or may carry one, two, or three radicals selected from the group consisting of C₁-C₄-alkoxy, C₁-C₄-alkylthio, C₁-C₄-alkylsulfinyl, C₁-C₄-alkylsulfonyl, C₁-C₄-haloalkoxy, C₁-C₄-haloalkylthio, C₁-C₄-alkoxycarbonyl, cyano, amino, (C₁-C₄-alkyl)amino, di-(C₁-C₄-alkyl)amino, C₃-C₈-cycloalkyl and phenyl, it being possible for phenyl to be unsubstituted, partially or fully halogenated and/or to carry one, two or three substituents selected from the group consisting of C₁-C₄-alkyl, C₁-C₄-haloalkyl, C₁-C₄-alkoxy, C₁-C₄-haloalkoxy; and
R³, R⁴ and R⁵ are independently of one another selected from the group consisting of hydrogen, halogen, cyano, nitro, C₁-C₆-alkyl, C₃-C₈-cycloalkyl, C₁-C₄-haloalkyl, C₁-C₄-alkoxy, C₁-C₄-alkylthio, C₁-C₄-alkylsulfinyl, C₁-C₄-alkylsulfonyl, C₁-C₄-haloalkoxy, C₁-C₄-haloalkylthio, C₂-C₆-alkenyl, C₂-C₆-alkinyl, C₁-C₄-alkoxycarbonyl, amino, (C₁-C₄-alkyl)amino, di-(C₁-C₄-alkyl)amino, aminocarbonyl, (C₁-C₄-alkyl)aminocarbonyl and di-(C₁-C₄-alkyl)aminocarbonyl;
and/or at least one salt thereof.
